(19) United States
(12) Patent Application Publication
(10) Pub. No.: US 2021/0014047 A1
(43) Pub. Date: Jan. 14, 2021

(54) METHODS, SYSTEMS, APPARATUS, AND ARTICLES OF MANUFACTURE TO MANAGE ACCESS TO DECENTRALIZED DATA LAKES

(71) Applicant: Intel Corporation, Santa Clara, CA (US)

(72) Inventors: Francesc Guim Bernat, Barcelona (ES); Kshitij Arun Doshi, Tempe, AZ (US); Ned M. Smith, Beaverton, OR (US); Uzair Qureshi, Chandler, AZ (US); Timothy Verrall, Pleasant Hill, CA (US)

(21) Appl. No.: 17/032,824

(22) Filed: Sep. 25, 2020

(51) Int. Cl. H04L 9/08; G06F 21/60; G06F 21/62

(52) U.S. Cl. CPC H04L 9/0822; G06F 21/6218; H04L 9/0872; G06F 21/602

(57) ABSTRACT

An apparatus to manage a data lake is disclosed. A disclosed example apparatus includes a location selector to select an edge device to store the data lake, a key generator to, in response to an indication that a service is authorized to access the data lake, generate an encryption key corresponding to the data lake and generate a key wrapping key corresponding to the edge device, and a key distributor to wrap the encryption key using the key wrapping key, and distribute the encryption key and the key wrapping key to the edge device, the encryption key to enable the service on the edge device to access the data lake.

### TECHNICAL FIELD

Embodiments described herein generally relate to data processing, network communication, and communication system implementations, and in particular, to methods, systems, apparatus, and articles of manufacture to manage access to data lakes.

### BACKGROUND

Edge computing, at a general level, refers to the transition of compute and storage resources closer to endpoint devices (e.g., consumer computing devices, user equipment, etc.) to optimize total cost of ownership, reduce application latency, improve service capabilities, and improve compliance with security or data privacy requirements. Edge computing may, in some scenarios, provide a cloud-like distributed service. As a result, some implementations of edge computing have been referred to as the “edge cloud” or the “fog”, as computing resources previously available only in large remote data centers are moved closer to endpoints and made available for use by consumers at the “edge” of the network.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an overview of an edge cloud configuration for edge computing.

FIG. 2 illustrates operational layers among endpoints, an edge cloud, and cloud computing environments.

FIG. 3 illustrates a block diagram of an example environment for networking and services in an edge computing system.

FIG. 4 illustrates deployment of a virtual edge configuration in an edge computing system operated among multiple edge nodes and multiple tenants.

FIG. 5 illustrates various compute arrangements deploying containers in an edge computing system.

FIG. 6 illustrates an example compute and communication use case involving mobile access to applications in an example edge computing system.

FIG. 7A is a block diagram of an example implementation of an example compute node that may be deployed in one of the edge computing systems illustrated in FIGS. 1-4 and/or 6.

FIG. 7B is another block diagram of an example implementation of an example compute node that may be deployed in one of the edge computing systems illustrated in FIGS. 1-4 and/or 6.

FIG. 8 illustrates a function-based real-time service edge workflow.

FIG. 9 illustrates an overview of a micro-data lakes registry architecture that can be implemented by the edge computing system of FIG. 2.

FIG. 10 illustrates a block diagram of a data lake manager implemented by the micro-data lakes registry of FIG. 9.

FIG. 11 illustrates a block diagram of a secondary manager implemented by the micro-data lakes registry of FIG. 9.

FIG. 12 is a flowchart representative of machine readable instructions which may be executed to implement the data lake manager of FIGS. 9 and/or 10 to manage the micro-data lakes registry of FIG. 9.

FIG. 13 is a flowchart representative of machine readable instructions which may be executed to implement the data lake manager of FIGS. 9 and/or 10 to create a data lake region.

FIG. 14 is a flowchart representative of machine readable instructions which may be executed to implement the data lake manager of FIGS. 9 and/or 10 to remove a data lake region.

FIG. 15 is a flowchart representative of machine readable instructions which may be executed to implement the data lake manager of FIGS. 9 and/or 10 to add a service to a data lake region.

FIG. 16 is a flowchart representative of machine readable instructions which may be executed to implement the data lake manager of FIGS. 9 and/or 10 to remove a service from a data lake region.

FIG. 17 is a flowchart representative of machine readable instructions which may be executed to implement the secondary manager of FIGS. 9 and/or 11 to read data from a data lake region to a service.

FIG. 18 is a flowchart representative of machine readable instructions which may be executed to implement the secondary manager of FIGS. 9 and/or 11 to write data to a data lake region from a service.

### DETAILED DESCRIPTION

Edge computing use cases in mobile network settings have been developed for integration with multi-access edge computing (MEC) approaches, also known as “mobile edge computing.” MEC approaches are designed to allow application developers and content providers to access computing capabilities and an information technology (IT) services environment in dynamic mobile network settings at the edge of the network. Limited standards have been developed by the European Telecommunications Standards Institute (ETSI) industry specification group (ISG) in an attempt to define common interfaces for operation of MEC systems, platforms, hosts, services, and applications.

Edge computing, MEC, and related technologies attempt to provide reduced latency, increased responsiveness, and more available computing power than offered in traditional cloud network services and wide area network connections. However, the integration of mobility and dynamically launched services to some mobile use and device processing use cases has led to limitations and concerns with orchestration, functional coordination, and resource management, especially in complex mobility settings where many participants (devices, hosts, tenants, service providers, operators) are involved.

In a similar manner, Internet of Things (IoT) networks and devices are designed to offer a distributed compute arrangement, from a variety of endpoints. IoT devices are physical or virtualized objects that may communicate on a network, and may include sensors, actuators, and other input/output components, which may be used to collect data or perform actions in a real world environment. For example, IoT devices may include low-powered endpoint devices that are embedded or attached to everyday things, such as buildings, vehicles, packages, etc., to provide an additional level of artificial sensory perception of those things. Recently, IoT devices have become more popular and thus applications using these devices have proliferated.

The deployment of various Edge, Fog, MEC, and IoT networks, devices, and services have introduced a number of advanced use cases and scenarios occurring at and towards the edge of the network. However, these advanced use cases have also introduced a number of corresponding technical challenges relating to security, processing and network resources, service availability and efficiency, among many other issues. One such challenge is in relation to managing access to data stored in one or more data lakes, and managing the creation, removal, and/or modification of the one or more data lakes.

In recent years, data analytics have increasingly been performed at edges of a network. Data can typically land on multiple tiers of an edge, where each tier can include cell towers, on-premise equipment, or cloudlets, and/or other edge devices. Data ingestion and processing capabilities at each tier may be different, and each tier may have different bandwidth, latency, and processing requirements. Further, participating entities (e.g., tenants) may land on or across one or more tiers of the edge, and each tenant may require access to data at different edge devices of the network. Access to and processing of data at the edge environment is highly dynamic and evolves over time. As such, edge infrastructures that are scalable allow for increasing amounts and types of data to be processed, and allow for an increasing number of devices to be dynamically connected to the network.

Data in the edge environment can be stored in data lakes. As used herein, a data lake refers to a storage and/or repository that can store both unstructured (e.g., raw) data and structured data at any scale. A data lake region refers to a region or partition of the data lake, where each data lake can be partitioned into any number of data lake regions of varying size. The data lake regions corresponding to a data lake can be stored across one or more edge devices. Partitioning of the data lake into data lake regions increases privacy of the data stored therein, as each tenant (e.g., user, entity requesting access, etc.) can be granted access only to particular regions of the data lake. Additionally, encryption and/or decryption of data can occur at the level of an individual data lake region to avoid having to encrypt and/or decrypt an entire corresponding data lake, thereby reducing processing times.

In the following description, example methods, configurations, and related apparatuses are disclosed for managing the creation, removal, and/or modification of data lakes stored at one or more edge devices. Further, examples disclosed herein are used to manage access of one or more edge entities (e.g., services, tenants) to the data lakes. An example data lake manager disclosed herein can add or remove an entity to or from a data lake region based on a registration procedure. A registry (e.g., micro-data lakes registry) is used to identify the authorized entities and the level of access granted to each authorized entity. Advantageously, the registry provides increased security and reduces the need to authorize an entity prior to each instance of accessing the data lake region, thereby providing streamlined access to the data.

Example techniques and configurations disclosed herein may be utilized in connection with many aspects of current networking systems, but are provided with reference to Edge Cloud, IoT, Multi-access Edge Computing (MEC), and other distributed computing deployments. The following systems and techniques may be implemented in, or augment, a variety of distributed, virtualized, or managed edge computing systems. These include environments in which network services are implemented or managed using multi-access edge computing (MEC) or 4G/5G wireless network configurations; or in wired network configurations involving fiber, copper, and other connections. Further, aspects of processing by the respective computing components may involve computational elements which are in geographical proximity of a user equipment or other endpoint locations, such as a smartphone, vehicular communication component, IoT device, etc. Further, the presently disclosed techniques may relate to other Edge/MEC/IoT network communication standards and configurations, and other intermediate processing entities and architectures.

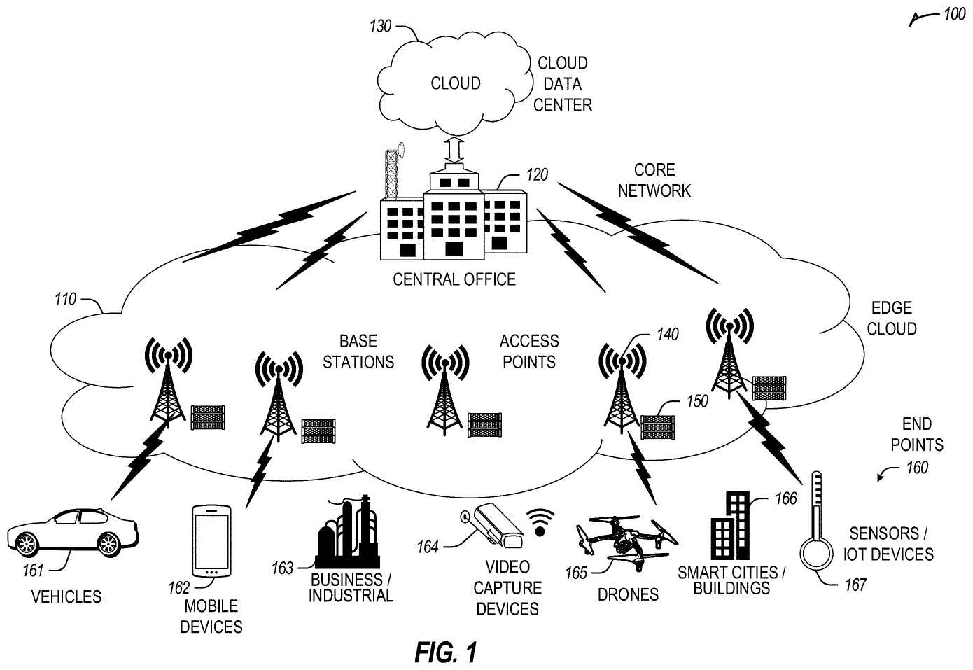

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

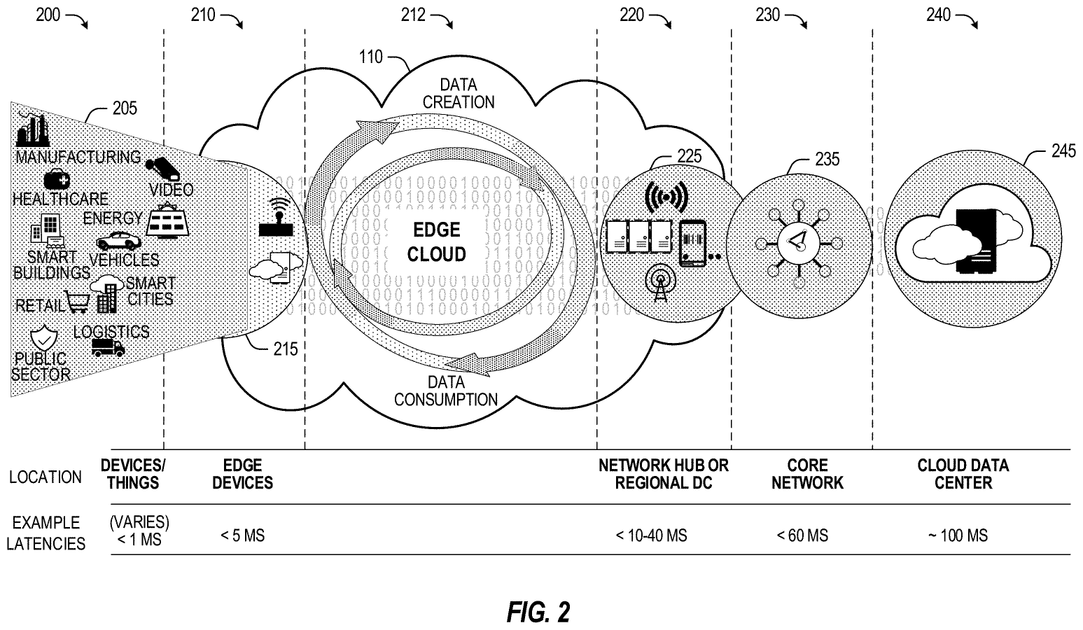

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

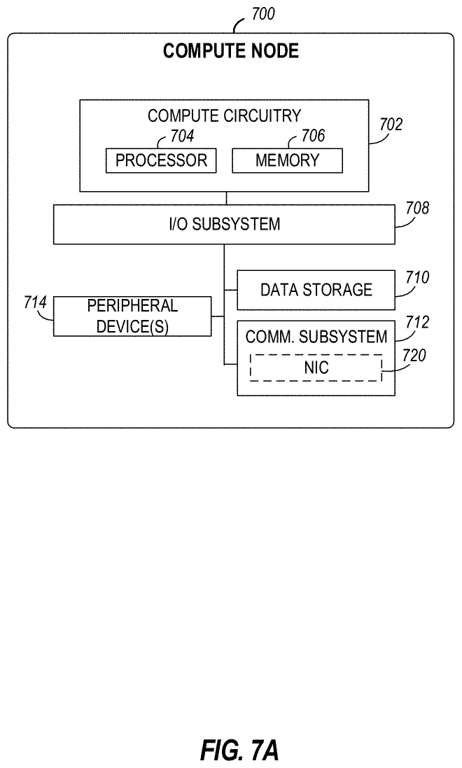

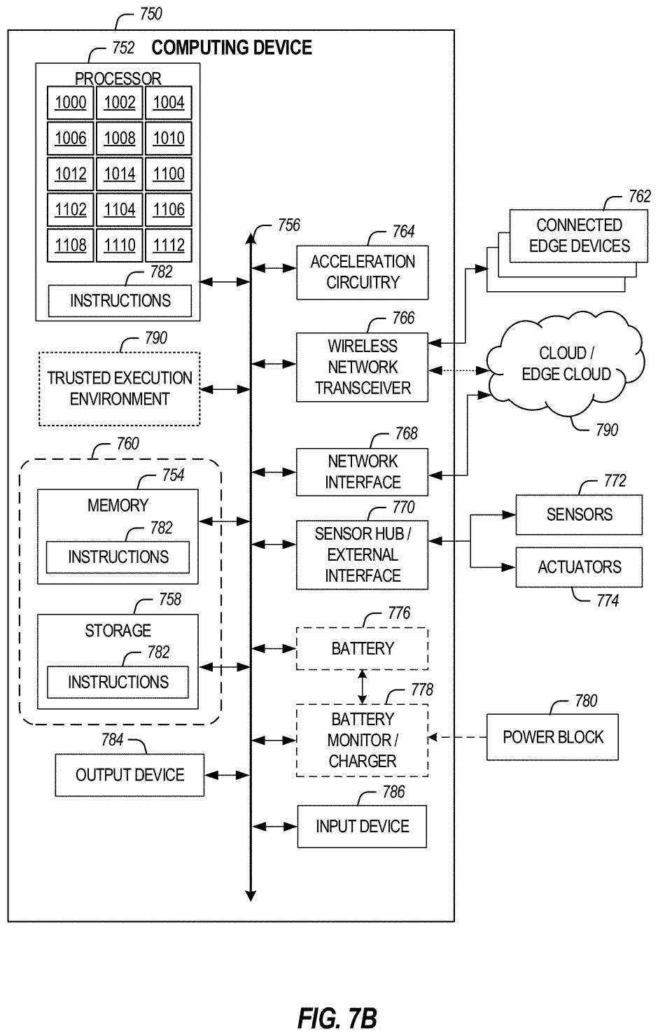

The network components of the edge cloud 110 may be servers, multi-tenant servers, appliance computing devices, and/or any other type of computing devices. For example, the edge cloud 110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 7B (described in further detail below). The edge cloud 110 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

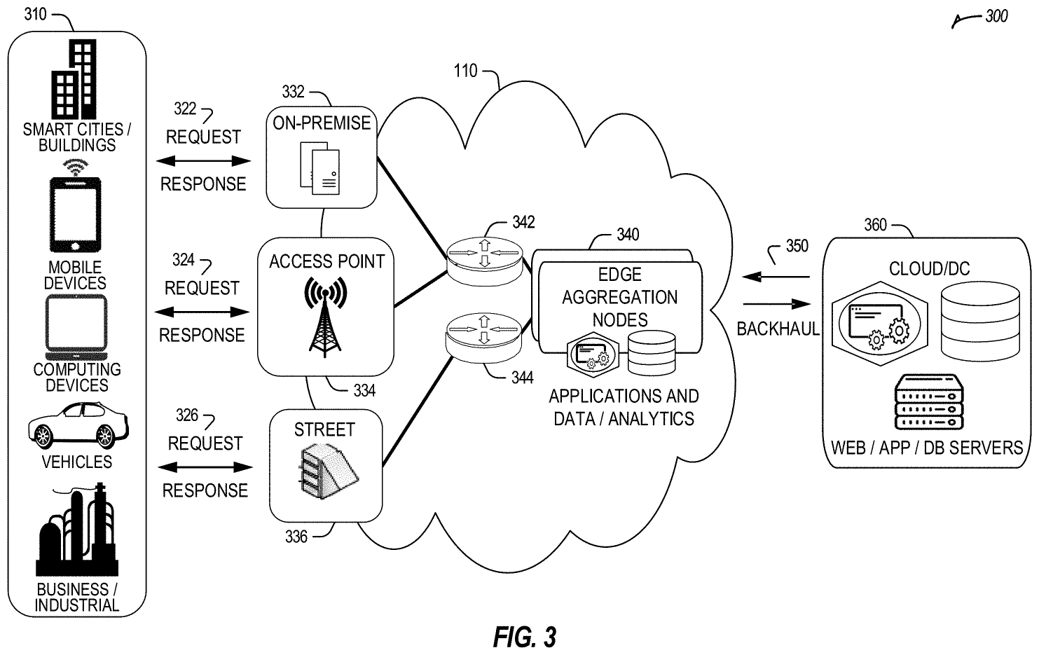

FIG. 3 illustrates a block diagram of an example environment 300 in which various client endpoints 310 (in the form of mobile devices, computers, autonomous vehicles, business computing equipment, industrial processing equipment) exchange requests and responses with the example edge cloud 110. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

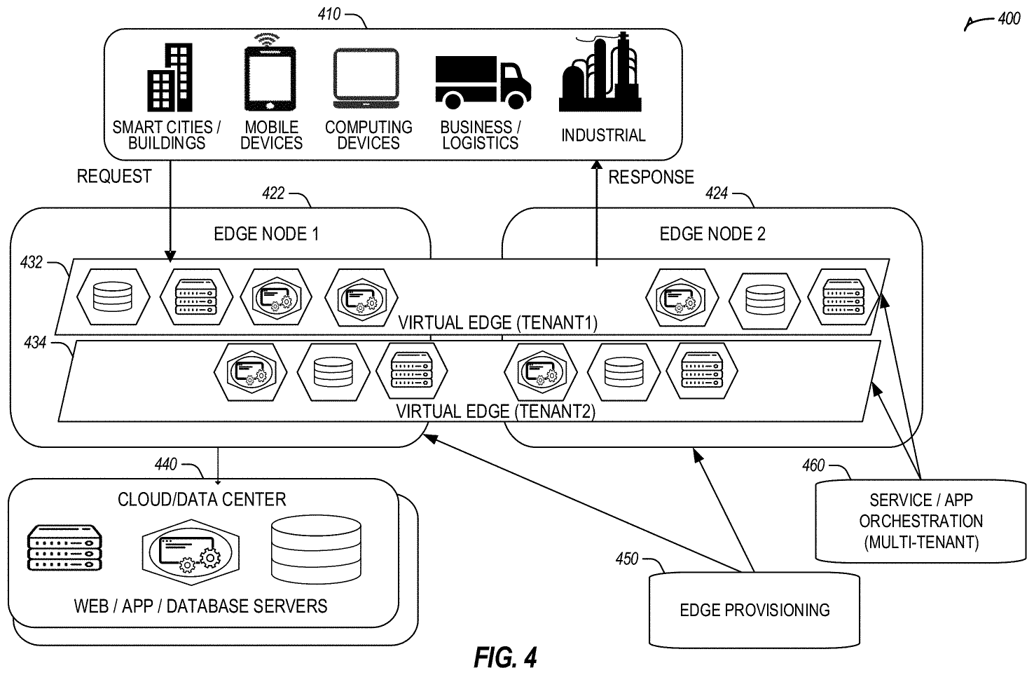

FIG. 4 illustrates deployment and orchestration for virtual edge configurations across an edge computing system operated among multiple edge nodes and multiple tenants. Specifically, FIG. 4 depicts coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

It should be understood that some of the devices 410 are multi-tenant devices where Tenant 1 may function within a tenant1 ‘slice’ while a Tenant 2 may function within a tenant2 ‘slice’ (and, in further examples, additional or sub-tenants may exist; and each tenant may even be specifically entitled and transactionally tied to a specific set of features all the way day to specific hardware features). A trusted multi-tenant device may further contain a tenant-specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective devices 410, 422, and 440 spanning RoTs may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each of the edge nodes 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 432, 434 are partitioned according to the needs of each container.

With the use of container pods, a pod controller oversees the partitioning and allocation of containers and resources. The pod controller receives instructions from an orchestrator (e.g., the orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

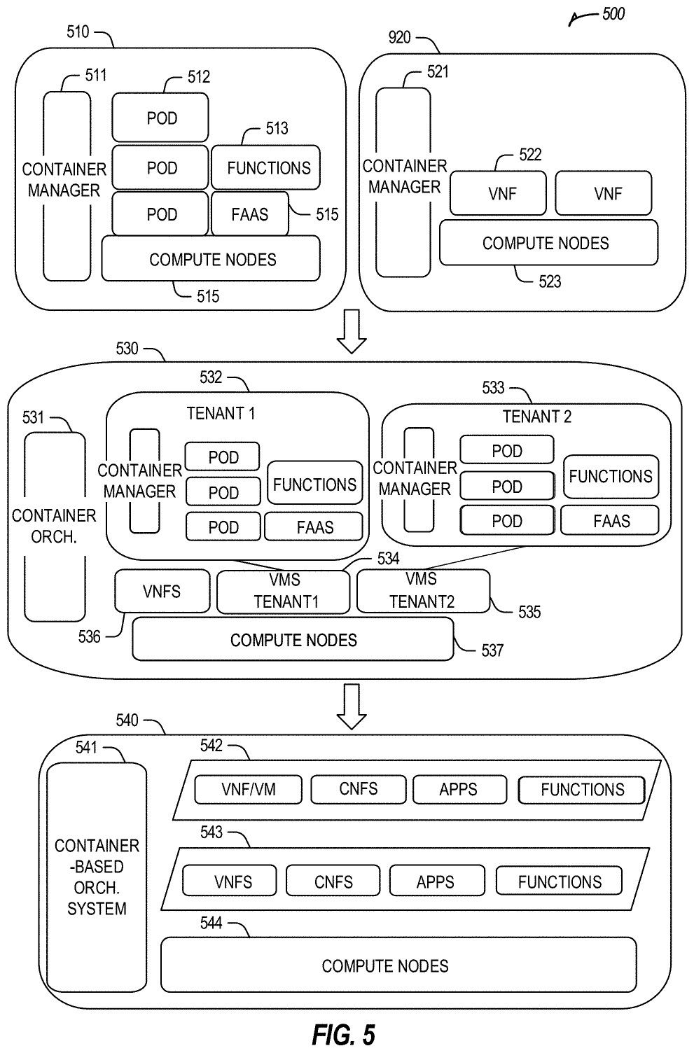

FIG. 5 illustrates additional compute arrangements deploying containers in an edge computing system. As a simplified example, system arrangements 510, 520 depict settings in which a pod controller (e.g., container managers 511, 521, and a container orchestrator 531) is adapted to launch containerized pods, functions, and functions-as-a-service instances through execution via compute nodes (515 in arrangement 510), or to separately execute containerized virtualized network functions through execution via compute nodes (523 in arrangement 520). This arrangement is adapted for use of multiple tenants in an example system arrangement 530 (using compute nodes 537), where containerized pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside the execution of virtualized network functions). This arrangement is further adapted for use in system arrangement 540, which provides containers 542, 543, or execution of the various functions, applications, and functions on compute nodes 544, as coordinated by an container-based orchestration system 541.

The system arrangements of depicted in FIG. 5 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

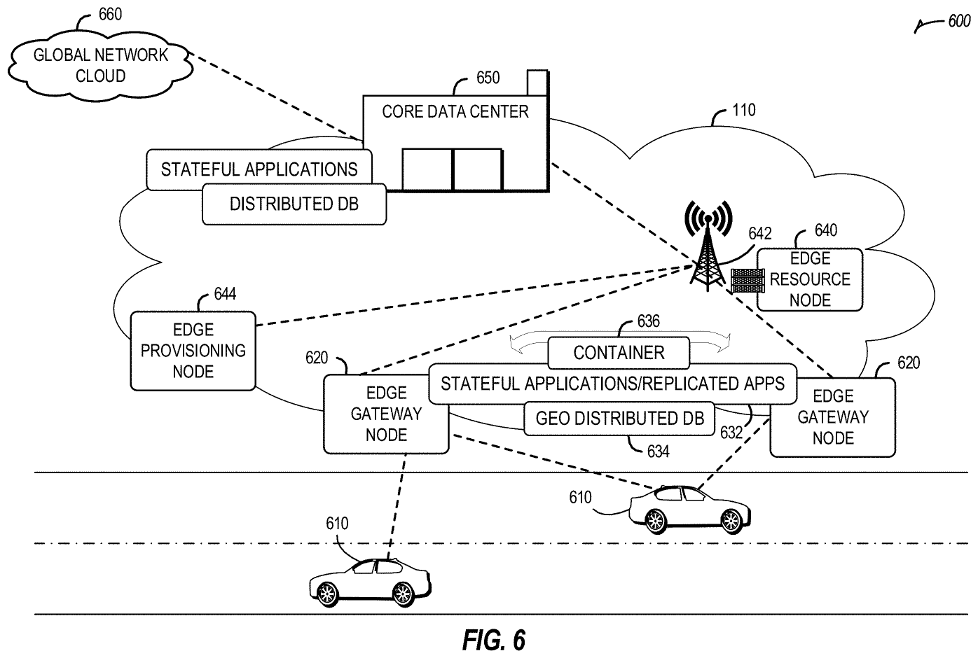

It should be appreciated that the edge computing systems and arrangements discussed herein may be applicable in various solutions, services, and/or use cases involving mobility. As an example, FIG. 6 shows an example simplified vehicle compute and communication use case involving mobile access to applications in an example edge computing system 600 that implements an edge cloud such as the edge cloud 110 of FIG. 0.1. In this use case, respective client compute nodes 610 may be embodied as in-vehicle compute systems (e.g., in-vehicle navigation and/or infotainment systems) located in corresponding vehicles which communicate with example edge gateway nodes 620 during traversal of a roadway. For instance, the edge gateway nodes 620 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 610 and a particular one of the edge gateway nodes 620 may propagate so as to maintain a consistent connection and context for the example client compute node 610. Likewise, mobile edge nodes may aggregate at the high priority services or according to the throughput or latency resolution requirements for the underlying service(s) (e.g., in the case of drones). The respective edge gateway devices 620 include an amount of processing and storage capabilities and, as such, some processing and/or storage of data for the client compute nodes 610 may be performed on one or more of the edge gateway nodes 620.

The edge gateway nodes 620 may communicate with one or more edge resource nodes 640, which are illustratively embodied as compute servers, appliances or components located at or in a communication base station 642 (e.g., a based station of a cellular network). As discussed above, the respective edge resource node(s) 640 include an amount of processing and storage capabilities and, as such, some processing and/or storage of data for the client compute nodes 610 may be performed on the edge resource node(s) 640. For example, the processing of data that is less urgent or important may be performed by the edge resource node(s) 640, while the processing of data that is of a higher urgency or importance may be performed by the edge gateway devices 620 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 640 also communicate with the core data center 650, which may include compute servers, appliances, and/or other components located in a central location (e.g., a central office of a cellular communication network). The example core data center 650 provides a gateway to the global network cloud 660 (e.g., the Internet) for the edge cloud 110 operations formed by the edge resource node(s) 640 and the edge gateway devices 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource node(s) 640 may offer the use of stateful applications 632 and a geographic distributed database 634. Although the applications 632 and database 634 are illustrated as being horizontally distributed at a layer of the edge cloud 110, it will be understood that resources, services, or other components of the application may be vertically distributed throughout the edge cloud (including, part of the application executed at the client compute node 610, other parts at the edge gateway nodes 620 or the edge resource node(s) 640, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 636 (or pod of containers) may be flexibly migrated from one of the edge nodes 620 to other edge nodes (e.g., another one of edge nodes 620, one of the edge resource node(s) 640, etc.) such that the container with an application and workload does not need to be reconstituted, re-compiled, re-interpreted in order for migration to work. However, in such settings, there may be some remedial or “swizzling” translation operations applied. For example, the physical hardware at the edge resource node(s) 640 may differ from the hardware at the edge gateway nodes 620 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 6 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node(s) 640, and others in the core data center 650 or global network cloud 660.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The edge computing system 600 can include or be in communication with an edge provisioning node 644. The edge provisioning node 644 can distribute software such as the example computer readable instructions 782 of FIG. 7B, to various receiving parties for implementing any of the methods described herein. The example edge provisioning node 644 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 644. For example, the entity that owns and/or operates the edge provisioning node 644 may be a developer, a seller, and/or a licensor (or a customer and/or consumer thereof) of software instructions such as the example computer readable instructions 782 of FIG. 7B. The receiving parties may be consumers, service providers, users, retailers, OEMs, etc., who purchase and/or license the software instructions for use and/or re-sale and/or sub-licensing.

In an example, edge provisioning node 644 includes one or more servers and one or more storage devices. The storage devices host computer readable instructions such as the example computer readable instructions 782 of FIG. 7B, as described below. Similarly to edge gateway devices 620 described above, the one or more servers of the edge provisioning node 644 are in communication with a base station 642 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third party payment entity. The servers enable purchasers and/or licensors to download the computer readable instructions 782 from the edge provisioning node 644. For example, the software instructions, which may correspond to the example computer readable instructions 782 of FIG. 7B, may be downloaded to the example processor platform/s, which is to execute the computer readable instructions 782 to implement the methods described herein.

In some examples, the processor platform(s) that execute the computer readable instructions 782 can be physically located in different geographic locations, legal jurisdictions, etc. In some examples, one or more servers of the edge provisioning node 644 periodically offer, transmit, and/or force updates to the software instructions (e.g., the example computer readable instructions 782 of FIG. 7B) to ensure improvements, patches, updates, etc. are distributed and applied to the software instructions implemented at the end user devices. In some examples, different components of the computer readable instructions 782 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

In further examples, any of the compute nodes or devices discussed with reference to the present edge computing systems and environment may be fulfilled based on the components depicted in FIGS. 7A and 7B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

FIG. 7A is a block diagram of an example implementation of an example edge compute node 700 that includes a compute engine (also referred to herein as “compute circuitry”) 702, an input/output (I/O) subsystem 708, data storage 710, a communication circuitry subsystem 712, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component. The example edge compute node 700 of FIG. 7A may be deployed in one of the edge computing systems illustrated in FIGS. 1-4 and/or 6 to implement any edge compute node of FIGS. 1-4 and/or 6.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, a processing unit, a specialized or special purpose processing unit, or other processor or processing/controlling circuit.

In some examples, the processor 704 may be embodied as, include, or be coupled to an FPGA, an application specific integrated circuit (ASIC), reconfigurable hardware or hardware circuitry, or other specialized hardware to facilitate performance of the functions described herein. Also, in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 and/or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems depending on, for example, the type of compute node 700.

The communication circuitry 712 may be embodied as any communication circuit, device, or collection thereof, capable of enabling communications over a network between the compute circuitry 702 and another compute device (e.g., an edge gateway of an implementing edge computing system). The communication circuitry 712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., an edge gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, and/or other levels.

Additionally, in some examples, a respective compute node 700 may include one or more peripheral devices 714. Such peripheral devices 714 may include any type of peripheral device found in a compute device or server such as audio input devices, a display, other input/output devices, interface devices, and/or other peripheral devices, depending on the particular type of the compute node 700. In further examples, the compute node 700 may be embodied by a respective edge compute node (whether a client, gateway, or aggregation node) in an edge computing system or like forms of appliances, computers, subsystems, circuitry, or other components.

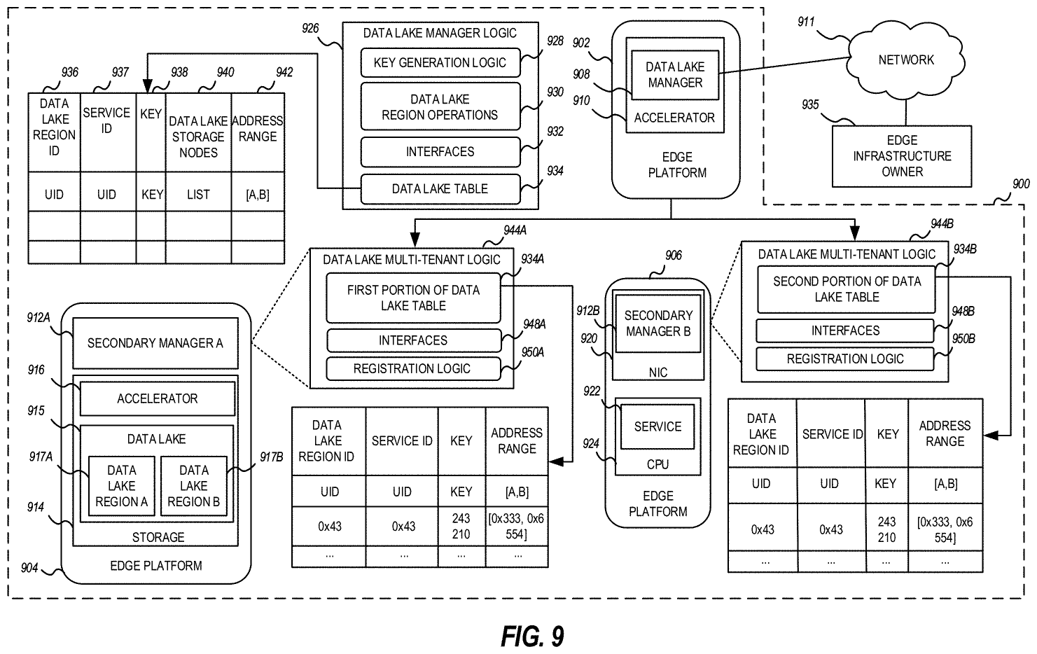

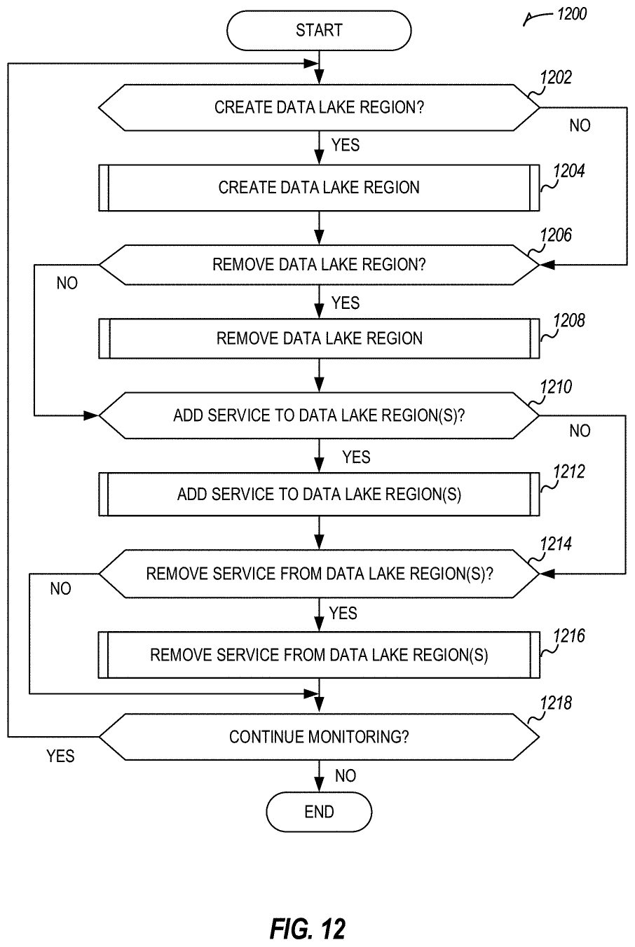

In a more detailed example, FIG. 7B illustrates a block diagram of an example may edge computing node 750 structured to execute the instructions of FIGS. 12, 13, 14, 15, 16, 17, and/or 18 to implement the techniques (e.g., operations, processes, methods, and methodologies) described herein such as the data lake manager 908 of FIGS. 9 and/or 10 and/or the secondary manager 912 of FIGS. 9 and/or 11. This edge computing node 750 provides a closer view of the respective components of node 700 when implemented as or as part of a computing device (e.g., as a mobile device, a base station, server, gateway, etc.). The edge computing node 750 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 750, or as components otherwise incorporated within a chassis of a larger system. For example, the edge computing node 750 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, an Internet of Things (IoT) device, or any other type of computing device.

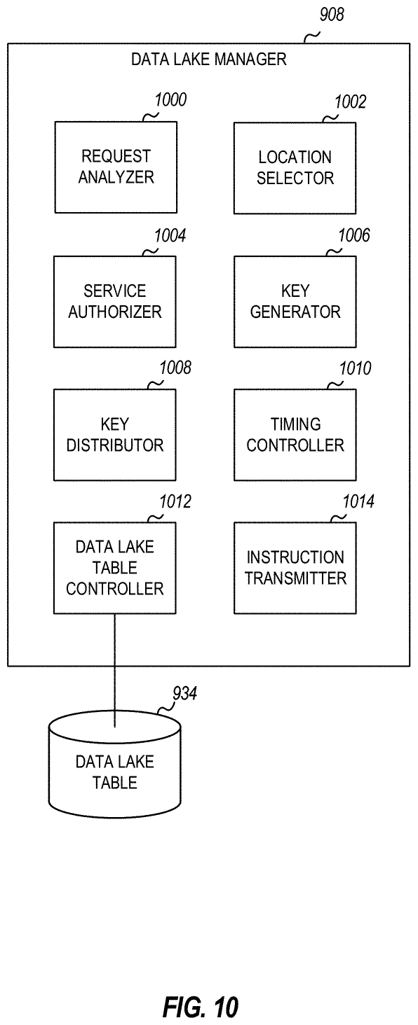

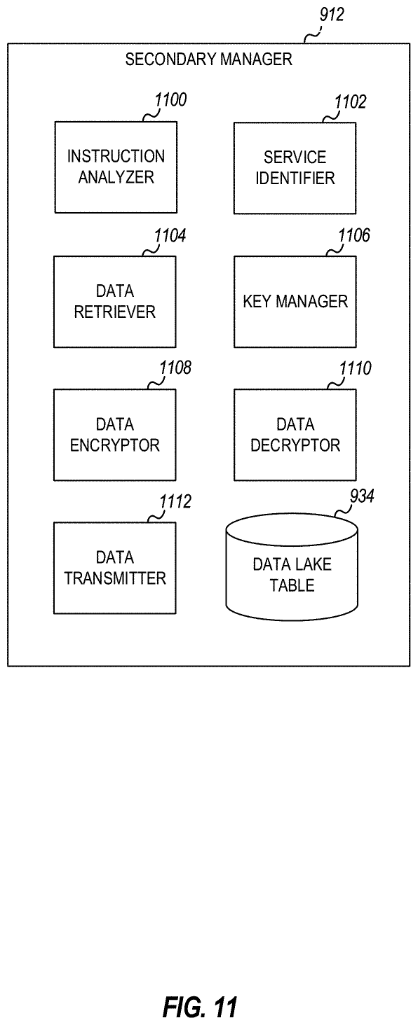

The edge computing device 750 may include processing circuitry in the form of a processor 752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, Calif. As an example, the processor 752 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B. In this example, the processor 752 implements one or more structural elements described below. For instance, the example processor 752 of FIG. 7B implements the example location selector 1002, the example service authorizer 1004, the example key generator 1006, the example key distributor 1008, the example data lake table controller 1012, and the example timing controller 1010 of FIG. 10 below, and the example instruction analyzer 1100, the example service identifier 1102, the example data retriever 1104, the example key manager 1106, the example data encryptor 1108, the example data decryptor 1110, and the example data transmitter 1112 of FIG. 11 below.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDlMMs or MiniDIMMs.

To provide for persistent storage of information such as data, applications, operating systems and so forth, a storage 758 may also couple to the processor 752 via the interconnect 756. In an example, the storage 758 may be implemented via a solid-state disk drive (SSDD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI express (PCIe), or any number of other technologies. The interconnect 756 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 756 may couple the processor 752 to a transceiver 766, for communications with the connected edge devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at a different range. For example, the edge computing node 750 may communicate with close devices, e.g., within about 10 meters, using a local transceiver based on Bluetooth Low Energy (BLE), or another low power radio, to save power. More distant connected edge devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in the edge cloud 795 via local or wide area network protocols. The wireless network transceiver 766 may be a low-power wide-area (LPWA) transceiver that follows the IEEE 802.15.4, or IEEE 802.15.4g standards, among others. The edge computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the edge cloud 795 or to other devices, such as the connected edge devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components 764, 766, 768, or 770. Accordingly, in various examples, applicable means for communicating (e.g., receiving, transmitting, etc.) may be embodied by such communications circuitry.

The edge computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the edge computing node 750 to actuators 774, such as power switches, valve actuators, an audible sound generator, a visual warning device, and the like.

In some optional examples, various input/output (I/O) devices may be present within or connected to, the edge computing node 750. For example, a display or other output device 784 may be included to show information, such as sensor readings or actuator position. An input device 786, such as a touch screen or keypad may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 750. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 776 may power the edge computing node 750, although, in examples in which the edge computing node 750 is mounted in a fixed location, it may have a power supply coupled to an electrical grid, or the battery may be used as a backup or for temporary capabilities. The battery 776 may be a lithium ion battery, or a metal-air battery, such as a zinc-air battery, an aluminum-air battery, a lithium-air battery, and the like.

A battery monitor/charger 778 may be included in the edge computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the edge computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the edge computing node 750. A wireless battery charging circuit, such as an LTC4020 chip from Linear Technologies of Milpitas, Calif., among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application specific integrated circuit (ASIC).

In an example, the instructions 782 provided via the memory 754, the storage 758, or the processor 752 may be embodied as a non-transitory, machine-readable medium 760 including code to direct the processor 752 to perform electronic operations in the edge computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices. The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 782 on the processor 752 (separately, or in combination with the instructions 782 of the machine readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 750 through the TEE 790 and the processor 752.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

The machine executable instructions 1200, 1300, 1400, 1500, 1600, 1700, and/or 1800 of FIGS. 12, 13, 14, 15, 16, 17, and/or 18 may be stored in the mass storage device 1028, in the volatile memory 1014, in the non-volatile memory 1016, and/or on a removable non-transitory computer readable storage medium such as a CD or DVD.

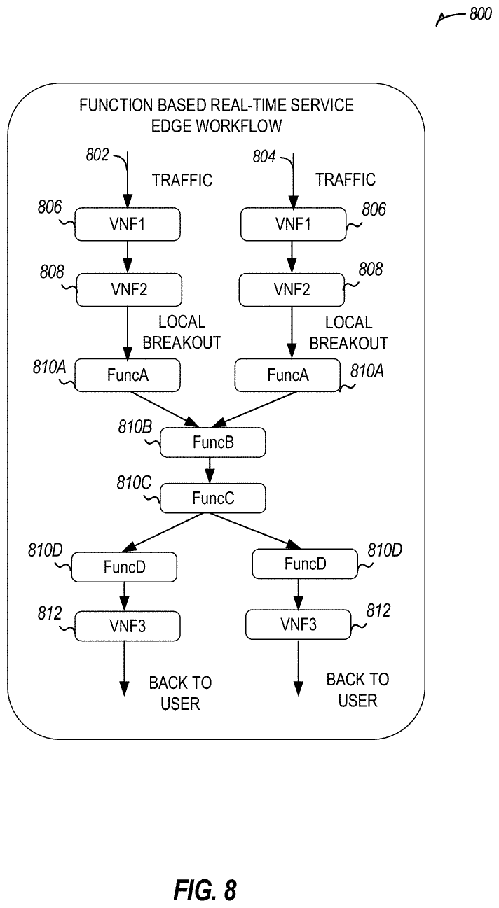

FIG. 8 illustrates an example function-based real-time service edge workflow (e.g., service edge workflow) 800. The example service edge workflow 800 of FIG. 8 can be implemented by the edge computing system 400 of FIG. 4. The example service edge workflow 800 shows a first data processing pipeline (DPP) 802 and a second DPP 804 that implement different chains of services having different network functions. In some examples, the network functions of the first DPP 802 and/or the second DPP 804 are distributed across one or more edge nodes (e.g., the first edge node 422 and the second edge node 424 of FIG. 4). In the illustrated example of FIG. 8, each of the first DPP 802 and the second DPP 804 can provide a tenant-specific chain of services. For example, the first DPP 802 provides first services to the first tenant 432 of FIG. 4 and the second DPP 804 provides second services to the second tenant 434.

In the illustrated example of FIG. 8, a first client from the client endpoints 410 of FIG. 4 sends a first request to the first DPP 802, and a second client from the client endpoints 410 sends a second request to the second DPP 804. In response, the first edge node 422 and the second edge node 424 execute the first services and the second services based on the chain of services corresponding to each of the first DPP 802 and the second DPP 804. In the illustrated example of FIG. 8, the first DPP 802 and the second DPP 804 include first virtual network functions (VNFs) 806 and second VNFs 808. In some examples, the first VNFs 806 correspond to a firewall VNF used to provide a security layer and prevent unnecessary network traffic along the edge nodes 422, 424. In some examples, each of the second VNFs 808 are a virtual evolved packet core (vEPC) VNFs. In other examples, each of the first VNFs 806 and the second VNFs 808 can be any other type of VNF (e.g., virus scanners, spam protection, video analytics, load balancing, etc.).

In examples disclosed herein, a VNF is a module that performs a specific low-level (e.g., packet processing level) network operation that was previously performed in a specialized multi-protocol router in hardware. In particular, a VNF is a piece of code that is usually executed repeatedly as packets flow into the VNF from a feeder. The VNF then sends information (e.g., in the form of modified and/or derived packets) to a successor VNF or to a sink. In some examples, a VNF is involved in a streaming operation that is performed over a packet stream passing through the VNF. In some examples, an EPC or vEPC VNF is tailored to high throughput, low latency operations for mobile telecommunications. Other example VNFs include load balancing and auto-scaling VNFs, deep packet inspection (DPI) VNFs, billing and charging VNFs, encap/decap VNFs, and/or logging VNFs. Some example VNFs arise in the context of Network Function Virtualization (NFV), in which hardware network operations are converted to software emulations of the hardware network operations. The motivation for NFV is to replace expensive and slowly-evolving hardware with inexpensive, highly-elastic, and fast-evolving combinations of software running on fast but low cost hardware.

In the illustrated example of FIG. 8, in response to passing through the first VNFs 806 and the second VNFs 808, the flow of data processing for the first DPP 802 and the second DPP 804 proceeds to a set of functions 810 (e.g., example first functions 810A, example second functions 810B, example third functions 810C, and example fourth functions 810D). In some examples, the set of functions 810 are functions that process a stream of images from the first client and the second client of the client endpoints 410. In response to processing the stream of images, the flow of data processing for the first DPP 802 and the second DPP 804 proceeds to a third VNF 812 before returning processed data to one or more users (e.g., the first client and/or the second client of the client endpoints 410).

In the illustrated example of FIG. 8, each of the first VNFs 806, the second VNFs 808, the third VNFs 812, and the set of functions 810 can be distributed between the first edge node 422 and the second edge node 424. In some examples, the edge computing system 400 stores and manages access to one or more data lakes based on an example edge architecture described below in connection with FIG. 9. In some examples, one or more of the services in the first DPP 802 and/or the second DPP 804 can store and/or retrieve data from data lakes stored at the first edge node 422 and/or the second edge node 424. The one or more services can access (e.g., read and/or write to) a data lake during execution of the first DPP 802 and/or the second DPP 804. In some examples, a managing entity (e.g., an Edge Infrastructure Owner) controls which data lakes and/or data lake regions are accessible to each of the one or more services.

FIG. 9 illustrates an overview of an example micro-data lakes registry architecture (e.g., registry, data lakes registry) 900 that can be implemented by the edge computing system 400 of FIG. 4. The example data lakes registry architecture 900 of FIG. 9 includes an example first edge platform (e.g., edge node, edge device) 902, an example second edge platform 904, and an example third edge platform 906. The example first edge platform 902 further includes an example data lake manager 908 implemented in an example first accelerator 910 and communicatively coupled to an example network 911. The example second edge platform 904 further includes an example secondary manager A 912A, an example storage 914 storing an example data lake 915, and an example second accelerator 916 implemented in the example storage 914. The example data lake 915 includes an example data lake region A (e.g., first data lake region) 917A and an example data lake region B (e.g., second data lake region) 917B. The example third edge platform 906 further includes an example secondary manager B 912B implemented in an example network interface controller (NIC) 920, and includes an example service 922 implemented in an example central processing unit (CPU) 924. In some examples, the service 922 can be any of the first VNFs 806, the second VNFs 808, the third VNFs 812, one or more of the set of functions 810 of FIG. 8 and/or combinations thereof.

The example data lake 915 includes data stored in the data lake region A 917A and the data lake region B 917B. In the illustrated example, both the data lake region A 917A and the data lake region B 917B are stored in the second edge platform 904. In other examples, the data lake region A 917A and the data lake region B 917B can be stored on different edge platforms. Each data lake region in the illustrated example (e.g., the data lake region A 917A and the data lake region B 917B) can be accessed by a corresponding set of services, where the corresponding set of services can be dynamically modified by the example secondary manager A 912A (e.g., in response to a request by the example data lake manager 908).

The example data lake 915 can be modified by creating, removing, expanding, and/or contracting the data lake regions (e.g., the data lake region A 917A and the data lake region B 917B) within the data lake 915. In some examples, each data lake region can be further divided into smaller data lake regions. For example, if the example service 922 of the third edge platform 906 is authorized to access only a portion of data in the data lake region A 917A, the data lake manager 908 can divide the data lake region A 917A into a first region including the portion of the data, and a second region including remaining data from the data lake region A 917A. As such, the data lake manager 908 can control granularity of data stored in the data lake 915 to ensure that access to the data is available only to those entities (e.g., the example third edge platform 906) having permission to access the data.

In the illustrated example of FIG. 9, the first edge platform 902 implements the data lake manager 908 to manage the creation, modification, and/or removal of one or more data lakes (e.g., the data lake 915) and/or data lake regions (e.g., the data lake region A 917A and the data lake region B 917B) stored in the data lakes registry architecture 900. Further, the example data lake manager 908 can add and/or remove a service having access to the data lake 915 and/or a region of the data lake 915 (e.g., the data lake region A 917A and/or the data lake region B 917B). The data lake manager 908 is controlled via example data lake manager logic 926. The data lake manager logic 926 further includes example key generation logic 928, example data lake region operations 930, example first interfaces 932, and an example data lake table 934.

Each entry of the data lake table 934 corresponds to a unique data lake region (e.g., the data lake region A 917A and/or the data lake region B 917B) in the data lakes registry architecture 900. An example entry of the data lake table 934 includes an example data lake region ID 936, an example service ID 937, an example key 938, example data lake storage nodes 940, and an example address range 942. The example data lake region ID 936 identifies a particular data lake region (e.g., the data lake region A 917B or the data lake region B 917B) to the data lake manager 908 and/or any of the other secondary data lake managers (e.g., the secondary manager A 912A, the secondary manager B 912B, etc.). The example service IDs 937 identify one or more services that are authorized to access one or more particular data lake regions. The example key 938 includes an encryption key used to encrypt and/or decrypt data in the particular data lake regions. The example data lake storage nodes 940 identify the one or more edge devices (e.g., the first edge platform 902, the second edge platform 904, and/or the third edge platform 906) that store the data lake region or a portion of the data lake region. The example address range 942 identifies a location within the edge devices in which the data lake region is stored. In some examples, the example address range 942 includes a first address range within a first edge device and a second address range within a second edge device.

The example first edge platform 902 can communicate with the second edge platform 904 and/or the third edge platform 906 via the first interfaces 932. Further, the data lake manager 908 can receive a request from an example Edge Infrastructure Owner (EIO) 935 via the network 911. The EIO 935 can be a service that performs lifecycle management operations and manages the data lakes and/or data lake regions of the data lakes registry architecture 900. In response to receiving and/or otherwise retrieving a request from the EIO 935, the data lake manager 908 executes the data lake region operations 930 to create, modify, or remove one or more data lakes (e.g., the data lake 915) and/or one or more data lake regions (e.g., the data lake region A 917A and/or the data lake region B 917B) in the data lakes registry architecture 900. In some examples, in response to receiving the request, the data lake manager 908 executes the data lake region operations 930 to add or remove a service (e.g., the service 922) to and/or from a data lake region. In some examples, the data lake manager 908 is not implemented inside an accelerator (e.g., the accelerator 910). In such examples, the data lake manager 908 can instead be implemented entirely in software and executed by general purpose CPUs.

In the illustrated example of FIG. 9, the second edge platform 904 implements the secondary manager A 912A to store and manage the data lake 915. The secondary manager A 912A executes example first data lake multi-tenant logic (e.g., first tenant logic) 944A which includes an example first portion 934A of the data lake table 934, example second interfaces A 948A, and example first registration logic 950A. The first portion 934A includes entries of the data lake table 934 that correspond to one or more data lake regions stored in the second edge platform 904. For example, the first portion 934A of the data lake table 934 can include the data lake region IDs 936, the service IDs 937, the keys 938, and the address ranges 942 corresponding to each of the data lake region A 917A and the data lake region B 917B. The second edge platform 904 can communicate with the first edge platform 902 and/or the third edge platform 906 via the second interfaces A 948A.

In the illustrated example of FIG. 9, the third edge platform 906 implements the secondary manager B 912B to manage access to the data lake 915 by one or more services (e.g., the service 922) in the data lakes registry architecture 900. The second manager B 912B executes example second data lake multi-tenant logic (e.g., second tenant logic) 944B which includes an example second portion 934B of the data lake table 934, example second interfaces B 948B, and example second registration logic 950B. The secondary manager B 912B is implemented in the NIC 920 which, in some examples, can be a smart NIC. In such examples, the NIC 920 can act as an accelerator for increasing speed of one or more network protocols, provide augmented data processing, and/or insert attestations in a stream of access by the service 922. The third edge platform 906 can communicate with the first edge platform 902 and/or the second edge platform 904 via the second interfaces B 948B.

In examples disclosed herein, the example data lake manager 908, the example secondary manager A 912A, and/or the example secondary manager B 912B is/are implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), graphics processing units (GPUs), etc.

FIG. 10 illustrates a block diagram of the data lake manager 908 implemented by the data lakes registry architecture 900 of FIG. 9. However, the illustrated example of FIG. 10 also illustrates a block diagram of any number of respective data lake managers that participate in the example data lake registry architecture 900 of FIG. 9 (e.g., the example secondary manager A 912A, the example secondary manager B 912B, etc.). Alternatively, the example secondary manager A 912A and/or the example secondary manager B 912B may be represented and/or otherwise implemented by the illustrated example of FIG. 11, described in further detail below. The data lake manager 908 includes an example request analyzer 1000, an example location selector 1002, an example service authorizer 1004, an example key generator 1006, an example key distributor 1008, an example timing controller 1010, an example data lake table controller 1012 coupled to the data lake table 934 of FIG. 9, and an example instruction transmitter 1014. In some examples, the request analyzer 1000 implements means for analyzing requests (sometimes referred to as a request analyzing means). In some examples, the location selector 1002 implements means for selecting location (sometimes referred to as a location selecting means). In some examples, the service authorizer 1004 implements means for authorizing a service (sometimes referred to as a service authorizing means). In some examples, the key generator 1006 implements means for generating keys (sometimes referred to as a key generating means). In some examples, the key distributor 1008 implements means for distributing keys (sometimes referred to as a key distributing means). In some examples, the timing controller 1010 implements means for controlling timing (sometimes referred to as a timing controlling means). In some examples, the data lake table controller 1012 implements means for controlling a data lake table (sometimes referred to as a data lake table controlling means).

The example request analyzer 1000 of FIG. 10 receives and/or otherwise retrieves a request from the EIO 935 of FIG. 9 and determines a type of the request. For example, the request analyzer 1000 determines whether the request is to add a data lake and/or add a data lake region, remove a data lake and/or remove a data lake region, modify a data lake and/or modify a data lake region, add a service to the data lakes registry architecture 900, and/or remove a service from the data lakes registry architecture 900. In response to determining the type of request, the request analyzer 1000 invokes and/or directs at least one of the location selector 1002, the service authorizer 1004, the key generator 1006, the key distributor 1008, the timing controller 1010, the data lake table controller 1012, and/or the instruction transmitter 1014 to execute the request, as described in further detail below. Additionally or alternatively, the request analyzer 1000 can receive the request from a service (e.g., the service 922) and/or from an edge platform (e.g., the second edge platform 904 and/or the third edge platform 906) of the data lakes registry architecture 900.

The location selector 1002 selects a location of a data lake (e.g., the data lake 915 of FIG. 9) and/or a data lake region (e.g., the data lake region A 917A and/or the data lake region B 917B of FIG. 9) from among one or more edge storage locations (e.g., the first edge platform 902, the second edge platform 904, and/or the third edge platform 906 of FIG. 9). For example, in response to the request analyzer 1000 receiving a request from the EIO 935 to create a new data lake region, the location selector 1002 selects one or more of the data lake storage nodes 940 to store the new data lake region, and further selects one or more address ranges 942 from within the selected data lake storage nodes 940. The location selector 1002 also selects a new location for an existing data lake region in response to a request from the EIO 935 to expand or contract the existing data lake region. In some examples, the location selector 1002 selects the location based on criteria (e.g., size of the data lake and/or data dake region) embedded in the request.

In some examples, a location of a data lake and/or data lake region is determined based on the type of request or query processing being performed, where the request or query identifies the one or more portions of data that need to be accessed. In some examples, a query corresponds to a subscriber who resides in France and the query originates in Germany. In such an example, during the process of performing the query, the subscriber is identified as being in France, and a subscriber record corresponding to the subscriber includes a region ID for France. As such, a first data lake in France may be selected based on the region ID. Alternatively, for examples in which the subscriber record is locally cached in a second data lake in Germany that is closer to where the query originated, the second data lake may be selected instead of the first data lake. In other examples, locations of data lakes and/or data lake regions are selected based on geo-political factors (e.g., the locations are selected from a list of countries where there are no information sharing treaties). In some other examples, the locations are selected based on access to low cost hosting sites, access to inexpensive power, and availability during off-peak hours.

The example service authorizer 1004 determines whether a service (e.g., the service 922 of FIG. 9) is authorized to access one or more of the selected data lake regions (e.g., the data lake region A 917A and/or the data lake region B 917B) in the data lakes registry architecture 900. For example, the service authorizer 1004 determines whether the service 922 is authorized based on attestations inserted by the NIC 920 of FIG. 9. In some examples, the service authorizer 1004 provides a voucher (e.g., an RFC8366 voucher) to register the service 922 as an authorized entity in the data lakes registry architecture 900. In some examples, the service authorizer 1004 determines which of the data lake regions the service 922 is authorized to access, and the level of access granted for each of the data lake regions. For example, the service authorizer 1004 can determine whether the service 922 can at least one of read, modify, or write to the data lake region A 917A and/or the data lake region B 917B.

The example key generator 1006 generates keys for accessing one or more data lake regions (e.g., the data lake region A 917A and/or the data lake region B 917B) of the data lakes registry architecture 900. In some examples, the key generator 1006 of FIG. 10 executes the key generation logic 928 of FIG. 9 to generate a region-specific symmetric data encryption key (e.g., RDEK, encryption key) corresponding to each requested data lake region. In some examples, the key generator 1006 generates an RDEK in response to creation of a new data lake region. In response to the data lake manager 908 creating the data lake 915 of FIG. 9, the key generator 1006 generates a unique RDEK corresponding to each data lake region included in the data lake 915. For example, the key generator 1006 generates a first RDEK for the data lake region A 917A, and a second RDEK for the data lake region B 917B, where the second RDEK is different from the first RDEK. The key generator 1006 can also generate a new RDEK corresponding to the data lake region A 917A and/or the data lake region B 917B in response to the service 922 being removed. For example, the key generator 1006 ensures and/or otherwise manages proper access to one or more data lakes and/or data lake region. As such, while the service 922 may be authorized to access a particular data lake region, such access can be revoked in response to the service 922 no longer needing access to the data lake region.

Additionally, the key generator 1006 can facilitate an even finer degree of granular control of the data lakes and/or data lake regions by generating a tenant-specific asymmetric key wrapping key (KWK) for each tenant (e.g., the first tenant 232 and/or the second tenant 234 of FIG. 2) participating in the data lakes registry architecture 900. In such examples, RDEKs are wrapped using the corresponding KWK to protect the RDEKs from use by unauthorized entities during provisioning and storage of the RDEKs. In some examples, KWKs can be bound to a trusted execution environment (TEE) such as Trusted Domain Extensions (TDX), Software Guard Extensions (SGX), or root of trust (e.g., DICE) such that the RDEKs are only visible while inside the TEE. For example, edge devices can implement accelerators (e.g., the first accelerator 910 and/or the second accelerator 916 of FIG. 9) inside a hardened environment to reduce exposure of the RDEKs to potential attackers having physical possession of the edge devices.

In some examples, the key generator 1006 can generate a seed value specific to a data lake region. In such examples, the seed value is used to derive an RDEK specific to the edge device on which the data lake region is stored. The RDEK specific to the edge device can be used to encrypt and/or decrypt data locally on the edge device. In some examples, the seed value can be stored in tamper-resistant hardware of the edge device, such as a physical unclonable function (PUF), to prevent exposure of the seed value in response to a physical attack. Additionally or alternatively, copies of data stored in a data lake region can be stored at a second location (e.g., second edge device or second data lake region) to ensure that the data remains accessible to services in the instance of a physical attack on the edge device.

In some examples, the key generator 1006 generates a homomorphic encryption key corresponding to a data lake region (e.g., the data lake region A 917A and/or the data lake region B 917B). In such examples, a service (e.g., the service 922) having the homomorphic encryption key accesses and/or performs calculations on data from the data lake region. For example, the service 922 having the homomorphic encryption key can perform calculations on encrypted data without first decrypting the data using an RDEK. In some such examples, resulting calculations on the data are also encrypted. For examples in which the service 922 has partial access (e.g., homomorphic access only) to the data lake region, the service 922 is provided the homomorphic encryption key. In such examples, the service 922 can decrypt data using the homomorphic encryption key, but does not fully decrypt the data to read or write to the data lake region. In particular, the example service 922 accesses only certain parts of the data, particular values of the data, and/or encrypted data from the data lake region. Alternatively, for examples in which the service 922 has full access (e.g., can read and/or write) to the data lake region, the service 922 is provided both the homomorphic encryption key and the RDEK corresponding to the data lake region. As such, the service 922 decrypts the data from the data lake region twice, first using the homomorphic encryption key, then using the RDEK.

The example key distributor 1008 distributes keys generated by the key generator 1006 to the one or more edge storage locations (e.g., the first edge platform 902, the second edge platform 904, and/or the third edge platform 906) of the data lakes registry architecture 900. For examples in which the service 922 is authorized to access the data lake region A 917A, in response to the key generator 1006 generating a new RDEK for the data lake region A 917A, the key distributor 1008 sends the new RDEK to the edge device hosting the service 922 (e.g., the third edge platform 906). Additionally, in such examples, the key distributor 1008 sends the new RDEK to the second edge platform 904 storing the data lake region A 917A for use by the secondary manager A 912A to encrypt and/or decrypt data of the data lake region A 917A. In some examples, in response to a new service being added to the data lakes registry architecture 900, the key distributor 1008 determines a set of RDEKs corresponding to the data lake regions accessible to the new service, then wraps the set of RDEKs using a KWK generated for the new service by the key generator 1006. The key distributor 1008 sends both the wrapped set of RDEKs and the KWK to the edge device hosting the new service. Additionally or alternatively, the key distributor 1008 can send a homomorphic encryption key corresponding to the data lake region A 917A to the edge device hosting the service 922 and/or to the second edge platform 904 storing the data lake region A 917A.

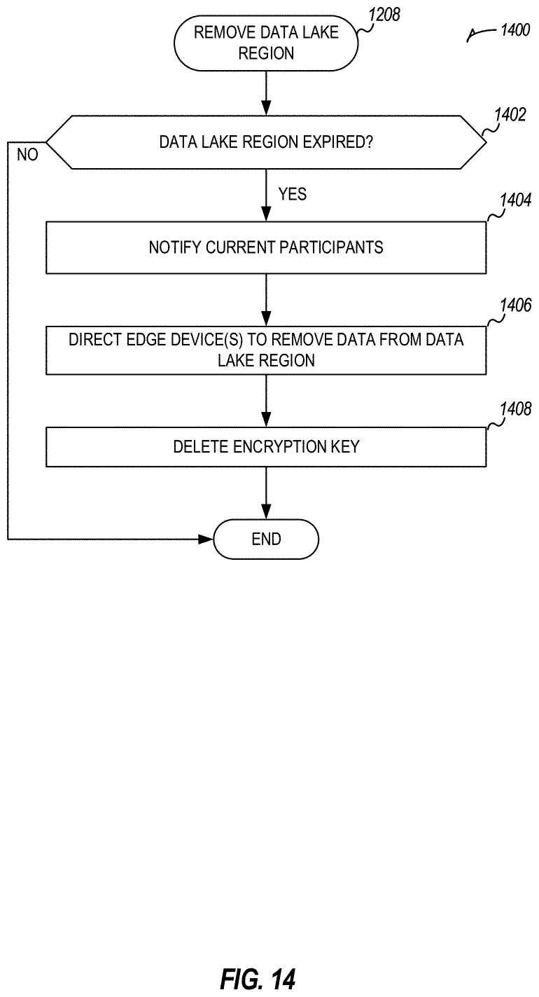

The example timing controller 1010 determines a duration for one or more data lake regions (e.g., the data lake region A 917A and/or the data lake region B 917B) in the data lakes registry architecture 900. For example, the timing controller 1010 determines an amount of time that has passed since the creation of the data lake region A 917A. In response to determining the amount of time exceeds a threshold duration corresponding to the data lake region A 917A, the timing controller 1010 determines that the data lake region A 917A has expired. In response to the timing controller 1010 determining that the data lake region A 917A has expired, the data lake manager 908 can take different measures to ensure data lake integrity and/or safety, such as removing the data lake region A 917A from the data lakes registry architecture 900 via the process described in connection with FIG. 14 below. In some examples, each of the data lake regions (e.g., the data lake region A 917A and/or the data lake region B 917B) in the data lakes registry architecture 900 can have a different duration (e.g., threshold duration value). In other examples, the data lake region A 917A can have an indefinite duration (e.g., the data lake region A 917A is not removed after a predetermined duration). In such examples, the timing controller 1010 can remove the data lake region A 917A from the data lakes registry architecture 900 in response to the request analyzer 1000 receiving a request from the EIO 935.

The example data lake table controller 1012 generates, removes, and/or modifies entries of the data lake table 934. For example, in response to the request analyzer 1000 receiving a request from the EIO 935 to create a new data lake region, the data lake table controller 1012 generates a new entry with parameters corresponding to the new data lake region. The parameters include, but are not limited to, a data lake region ID 936, a key 938 (e.g., RDEK and/or homomorphic encryption key) corresponding to the new data lake region, a location of the new data lake region (e.g., one or more data lake storage nodes 940 and address range 942), and service IDs 937 corresponding to services having access to the new data lake region. Alternatively, the data lake table controller 1012 can delete an entry from the data lake table 934 in response to the request analyzer 1000 receiving a request from the EIO 935 to remove a data lake region. In some examples, the data lake table controller 1012 can modify an entry in the data lake table 934 in response to a service being added to or removed from a data lake region. For example, in response to a new service being added to the data lake region A 917A, the data lake table controller 1012 can add a service ID 937 of the new service to the entry corresponding to the data lake region A 917A. Alternatively, in response to an expired service being removed from the data lake region A 917A, the data lake table controller 1012 can remove the service ID 937 of the expired service from the entry. The data lake table controller 1012 can also modify entries in response to the key generator 1006 generating a new RDEK for the data lake region A 917A, and/or in response to the location selector 1002 modifying (e.g., expanding or contracting) a storage location of the data lake region A 917A.

In some examples, in response to generating, removing, and/or modifying one or more entries of the data lake table 934, the data lake table controller 1012 can propagate the data lake table 934 or a portion of the data lake table 934 to each edge platform in the data lakes registry architecture 900. Additionally or alternatively, the data lake table controller 1012 can be configured and/or otherwise structured to propagate the data lake table 934 or a portion of the data lake table 934 periodically (e.g., hourly, daily, etc.).

The example instruction transmitter 1014 transmits instructions and/or information to the secondary manager A 912A of the second edge platform 904 and/or to the secondary manager B 912B of the third edge platform 906. For example, in response to the request analyzer 1000 receiving a request from the EIO 935 to create the data lake region A 917A, the instruction transmitter 1014 sends instructions to the secondary manager A 912A to encrypt data in the data lake region A 917A using a corresponding RDEK generated by the key generator 1006. In other examples, in response to the timing controller 1010 determining that the data lake region A 917A is expired, the instruction transmitter 1014 sends instructions to the second manager A 912A to remove and/or delete data in the data lake region A 917A. In some examples, in response to the request analyzer 1000 receiving a request from the EIO 935 to remove a service (e.g., the service 922) from the data lake region A 917A, the instruction transmitter 1014 sends instructions to the second manager A 912A to decrypt data from the data lake region A 917A using a current RDEK, and encrypt the data using a new RDEK distributed by the key distributor 1008. In other examples, the instruction transmitter 1014 can direct the secondary manager A 917A and/or the secondary manager B 917B to at least one of temporarily suspend access to a data lake region, encrypt or decrypt data of the data lake region, or update the data lake table 934 stored in the second edge platform 904 and/or the third edge platform 906.

While an example manner of implementing the data lake manager 908 of FIG. 9 is illustrated in FIG. 10, one or more of the elements, processes and/or devices illustrated in FIG. 10 may be combined, divided, re-arranged, omitted, eliminated and/or implemented in any other way. Further, the example request analyzer 1000, the example location selector 1002, the example service authorizer 1004, the example key generator 1006, the example key distributor 1008, the example timing controller 1010, the example data lake table controller 1012, the example instruction transmitter 1014, and/or, more generally, the example data lake manager 908 of FIG. 10 may be implemented by hardware, software, firmware and/or any combination of hardware, software and/or firmware. Thus, for example, any of the example request analyzer 1000, the example location selector 1002, the example service authorizer 1004, the example key generator 1006, the example key distributor 1008, the example timing controller 1010, the example data lake table controller 1012, the example instruction transmitter 1014, and/or, more generally, the example data lake manager 908 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example request analyzer 1000, the example location selector 1002, the example service authorizer 1004, the example key generator 1006, the example key distributor 1008, the example timing controller 1010, the example data lake table controller 1012, or the example instruction transmitter 1014 is/are hereby expressly defined to include a non-transitory computer readable storage device or storage disk such as a memory, a digital versatile disk (DVD), a compact disk (CD), a Blu-ray disk, etc. including the software and/or firmware. Further still, the example data lake manager 908 of FIG. 9 may include one or more elements, processes and/or devices in addition to, or instead of, those illustrated in FIG. 10, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

FIG. 11 illustrates a block diagram of an example secondary manager 912 (e.g., the secondary manager A 912A and/or the secondary manager B 912B) implemented by the data lakes registry architecture 900 of FIG. 9. In the illustrated example of FIG. 11, the secondary manager 912 executes instructions from the data lake manager 908 (e.g., primary manager) and/or from the service 922 to encrypt and/or decrypt data from the data lake 915 of FIG. 9. The secondary manager 912 includes the data lake table 934 of FIG. 9, an example instruction analyzer 1100, an example service identifier 1102, an example data retriever 1104, an example key manager 1106, an example data encryptor 1108, an example data decryptor 1110, and an example data transmitter 1112. In some examples, the instruction analyzer 1100 implements means for analyzing instructions (sometimes referred to as an instruction analyzing means). In some examples, the service identifier 1102 implements means for identifying a service (sometimes referred to as a service identifying means). In some examples, the data retriever 1104 implements means for retrieving data (sometimes referred to as a data retrieving means). In some examples, the key manager 1106 implements means for managing keys (sometimes referred to as a key managing means). In some examples, the data encryptor 1108 implements means for encrypting data (sometimes referred to as a data encryption means). In some examples, the data decryptor 1110 implements means for decrypting data (sometimes referred to as a data decrypting means). In some examples, the data transmitter 1112 implements means for transmitting data (sometimes referred to as a data transmitting means).

In operation, the example instruction analyzer 1100 receives instructions from the data lake manager 908 and/or from the service 922. In response to receiving the instructions, the instruction analyzer 1100 evokes and/or directs at least one of the service identifier 1102, the data retriever 1104, the key manager 1106, the data encryptor 1108, the data decryptor 1110, or the data transmitter 1112 to execute the instructions. The instructions can include at least one of reading data from a data lake region (e.g., the data lake region A 917A and/or the data lake region B 917B of FIG. 9) to the service 922, writing new data from the service 922 to a data lake region, and re-encrypting data in a data lake region in response to the data lake manager 908 generating a new RDEK for the data lake region.

The example service identifier 1102 identifies a service (e.g., the service 922) reading from, writing to, and/or otherwise accessing a data lake region (e.g., the data lake region A 917A and/or the data lake region B 917B). For example, the service identifier 1102 determines whether the service 922 is authorized to access the data lake region A 917A by identifying an entry of the data lake table 934 corresponding to the data lake region A 917A. The service identifier 1102 identifies a service ID 937 corresponding to the service 922, then determines whether the service ID 937 is included in the data lake table entry corresponding to the data lake region A 917A. In response to determining that the data lake table entry includes the service ID 937 corresponding to the service 922, the service identifier 1102 determines that the service 922 is authorized to access the data lake region A 917A. Alternatively, in response to the service identifier 1102 being unable to identify the service ID 937 and/or locate the identified service ID 937 in the data lake table entry, the service identifier 1102 determines that the service 922 is not authorized to access the data lake region A 917A and, thus, prevents the service 922 from reading from and/or writing to the data lake region A 917A.

The example data retriever 1104 retrieves data from a data lake region (e.g., the data lake region A 917A and/or the data lake region B 917B) and/or from a service (e.g., the service 922). In some examples, the data retriever 1104 obtains a location (e.g., address range 942) of the data lake region A 917A from an entry of the data lake table 934 corresponding to the data lake region A 917A. For example, in response to the instruction analyzer 1100 receiving instructions from the service 922 to read data from the data lake region A 917A, the data retriever 1104 retrieves the data stored at the location corresponding to the data lake region A 917A. In other examples, the data retriever 1104 retrieves the data in response to the instruction analyzer 1100 receiving instructions from the data lake manager 908 to re-encrypt the data in the data lake region A 917A.

The example key manager 1106 identifies an encryption key (e.g., RDEK) corresponding to the data lake region (e.g., the data lake region A 917A and/or the data lake region B 917B). In some examples, in response to the instruction analyzer 1100 receiving instructions from the service 922 to read data from and/or write new data to the data lake region A 917A, the key manager 1106 identifies and/or retrieves a current RDEK corresponding to the data lake region A 917A from the entry of the data lake table 934 corresponding to the data lake region A 917A. In such examples, the key manager 1106 sends the current RDEK to the data encryptor 1108 in response to the service 922 writing new data, and/or sends the current RDEK to the data decryptor 1110 in response to the service 922 reading data. In other examples, in response to the data lake manager 908 generating a new RDEK corresponding to the data lake region A 917A (e.g., to remove the service 922 from the data lake region A 917A), the key manager 1106 receives the new RDEK from the data lake manager 908 in addition to retrieving the current RDEK from the data lake table 934. In such examples, the key manager 1106 sends the current RDEK to the data decryptor 1110 and sends the new RDEK to the data encryptor 1108. In some examples, the key manager 1106 can add, modify, and/or delete an RDEK in the data lake table 934 in response to the instructions received by the instruction analyzer 1100. Additionally or alternatively, the key manager 1106 can identify, receive and/or otherwise retrieve a homomorphic encryption key corresponding to the data lake region A 917A and/or the data lake region B 917B from one or more entries of the data lake table 934. In some such examples, the key manager 1106 can send the homomorphic encryption key to the data decryptor 1110 and/or to the data encryptor 1108.

The example data encryptor 1108 encrypts data in a data lake region (e.g., the data lake region A 917A and/or the data lake region B 917B). For example, in response to the service 922 writing new data to the data lake region A 917A, the data encryptor 1108 receives the RDEK corresponding to the data lake region A 917A from the key manager 1106 and encrypts the new data using the RDEK. Additionally or alternatively, the data encryptor 1108 encrypts data in the data lake region using the homomorphic encryption key from the key manager 1106.

Alternatively, the example data decryptor 1110 decrypts data from a data lake region (e.g., the data lake region A 917A and/or the data lake region B 917B). For example, in response to the service 922 reading data from the data lake region A 917A, the data decryptor 1110 receives the data from the data retriever 1104 and receives the current RDEK corresponding to the data lake region A 917A from the key manager 1106, then decrypts the data using the current RDEK. In some examples, in response to the data lake manager 908 removing the service 922 from the data lake region A 917A, the data decryptor 1110 decrypts the data using the current RDEK, then the data encryptor 1108 encrypts the data using the new RDEK received from the key manager 1106. In some examples, the data encryptor 1108 and/or the data decryptor 1110 can be implemented inside an accelerator (e.g., the first accelerator 910 and/or the second accelerator 916 of FIG. 9) to speed up the encryption and/or decryption of data. Additionally or alternatively, the example data decryptor 1110 decrypts data in the data lake region using the homomorphic encryption key from the key manager 1106.

The data transmitter 1112 transmits data to and/or from a data lake region (e.g., the data lake region A 917A and/or the data lake region B 917B). For example, in response to the service 922 requesting the data from the data lake region A 917A, the data transmitter 1112 transmits the data decrypted by the data decryptor 1110 to the service 922. Alternatively, in response to the service 922 writing new data to the data lake region A 917A, the data transmitter 1112 transmits the new data encrypted by the data encryptor 1108 to the location of the data lake region A 917A. In such examples, the data transmitter 1112 determines the location based on the entry of the data lake table 934 corresponding to the data lake region A 917A.

While an example manner of implementing the secondary manager 912 of FIG. 9 is illustrated in FIG. 11, one or more of the elements, processes and/or devices illustrated in FIG. 11 may be combined, divided, re-arranged, omitted, eliminated and/or implemented in any other way. Further, the example instruction analyzer 1100, the example service identifier 1102, the example data retriever 1104, the example key manager 1106, the example data encryptor 1108, the example data decryptor 1110, the example data transmitter 1112, and/or, more generally, the example secondary manager 912 of FIG. 11 may be implemented by hardware, software, firmware and/or any combination of hardware, software and/or firmware. Thus, for example, any of the example instruction analyzer 1100, the example service identifier 1102, the example data retriever 1104, the example key manager 1106, the example data encryptor 1108, the example data decryptor 1110, the example data transmitter 1112, and/or, more generally, the example secondary manager 912 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example instruction analyzer 1100, the example service identifier 1102, the example data retriever 1104, the example key manager 1106, the example data encryptor 1108, the example data decryptor 1110, or the example data transmitter 1112 is/are hereby expressly defined to include a non-transitory computer readable storage device or storage disk such as a memory, a digital versatile disk (DVD), a compact disk (CD), a Blu-ray disk, etc. including the software and/or firmware. Further still, the example secondary manager 912 of FIG. 9 may include one or more elements, processes and/or devices in addition to, or instead of, those illustrated in FIG. 11, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Returning to FIG. 9, the secondary manager A 912A and the secondary manager B 912B work in conjunction with the data lake manager 908 (e.g., primary manager) to manage the data lakes registry architecture 900. For example, the data lake manager 908 controls the creation, removal, and/or modification of data lakes and/or data lake regions across the edge platforms (e.g., the first edge platform 902, the second edge platform 904, and/or the third edge platform 906) in the data lakes registry architecture 900. Alternatively, the secondary manager A 912A and the secondary manager B 912B manage encryption and decryption of data stored on the second edge platform 904 and the third edge platform 906, respectively. In some examples, the data lake manager 908 is implemented on a primary edge node (e.g., the first edge platform 902) and one of the secondary managers 912 is implemented on each additional edge platform and/or secondary edge node in the data lakes registry architecture 900.

In the illustrated example of FIG. 9, the data lake manager 908 can create a new data lake region (e.g., the data lake region A 917A) in response to a request from the EIO 935. For example, the request analyzer 1000 of FIG. 10 receives the request from the EIO 935 and determines that the request includes instructions to create the data lake region A 917A. The location selector 1002 of FIG. 10 defines data lake region parameters corresponding to the data lake region A 917A. For example, the data region parameters include a data lake region ID 936, one or more data lake storage nodes 940, and an address range 942 corresponding to the data lake region A 917A. For example, the data lake storage node 940 can be the second edge platform 904, and the address range 942 can define a location within the storage 914. In some examples, the location selector 1002 selects the location based on available storage in the one or more edge platforms and/or based on instructions from the EIO 935.

The key generator 1006 of FIG. 10 then executes the key generation logic 928 to generate a new RDEK corresponding to the new data lake region. The key distributor 1008 sends the new RDEK to the edge storage nodes (e.g., the second edge platform 904) storing the data lake region A 917A. In some examples, new data lake regions must be carefully protected from general access and/or protected from particular devices. For instance, some data lakes and/or data lake regions contain sensitive information that, if exposed to unauthorized devices and/or individuals, would violate jurisdictional regulations (e.g., General Data Protection Regulation (GDRP)). In some examples, the instruction transmitter 1014 of FIG. 10 instructs the second edge platform 904 to encrypt data in the data lake region A 917A using the new RDEK. As such, particular distribution of the RDEK facilitates efforts to comply with one or more security regulations (e.g., GCRP). Further, the data lake table controller 1012 of FIG. 10 generates a new entry of the data lake table 934 corresponding to the new data lake region, where the new entry includes the data lake region parameters and the new RDEK. In some examples, the data lake table controller 1012 sends the data lake table 934 and/or a portion (e.g., the first portion 934A) of the data lake table 934 to the edge storage nodes (e.g., the second edge platform 904). In some examples, the timing controller 1010 of FIG. 10 can assign a duration (e.g., length of time) to the data lake region A 917A upon creation of the data lake region A 917A.

Additionally or alternatively, the data lake manager 908 can expand or contract an existing data lake region (e.g., the data lake region A 917A). For example, the request analyzer 1000 receives a request from the EIO 935 to expand the data lake region A 917A. In such examples, the location selector 1002 defines a new address range 942A within the storage 914 of the second edge platform 904. In some examples, the new address range 942A corresponds to a storage location on a different edge platform (e.g., the first edge platform 902 and/or the third edge platform 906). The data lake table controller 1012 updates the entry of the data lake table 934 corresponding to the data lake region A 917A to include the new address range 942A. For examples in which the existing data lake region is expanded to a new edge platform (e.g., the third edge platform 906), the key distributor 1008 identifies the RDEK corresponding to the data lake region A 917A based on the data lake table 934, and transmits the RDEK to the new edge platform. Further, the data lake table controller 1012 updates the entry of the data lake table 934 corresponding to the data lake region A 917A to include the new edge platform in the data lake storage nodes 940.

In the illustrated example of FIG. 9, the data lake manager 908 can remove and/or delete a data lake region (e.g., the data lake region A 917A and/or the data lake region B 917B) from the data lakes registry architecture 900. In some examples, the data lake region is removed after expiration, which occurs after a duration of time has passed from creation of the data lake region. In some examples. the duration corresponding to the data lake region can be determined by the timing controller 1010 at the time of creation of the data lake region. In some examples, each data lake region in the data lakes registry architecture 900 can have a different duration. For example, the timing controller 1010 can assign a first duration to the data lake region A 917A and a second duration to the data lake region B 917B, where the second duration is different from the first duration.

In response to the timing controller 1010 determining that a data lake region has expired, the instruction transmitter 1014 can notify participating tenants and/or services having access to the data lake region that the data lake region is to be removed. In some examples, a copy of the data from the data lake region can be migrated to a second location in the data lakes registry architecture 900 prior to removal and/or deletion of the data lake region. To remove the data lake region A 917A from the second edge platform 904, the instruction transmitter 1014 directs the secondary manager A 912A to delete existing data stored in the data lake region A 917A and delete the RDEK corresponding to the data lake region A 917A from the first portion 934A of the data lake table 934. In some examples, the data lake region A 917A can be overwritten with new data instead of the secondary manager A 912A deleting the existing data. In some examples, the data lake table controller 1012 updates the data lake table 934 to delete the entry of the data lake table 934 corresponding to the data lake region A 917A.

In the illustrated example of FIG. 9, the data lake manager 908 can add a new service to a data lake region in the data lakes registry architecture 900. For example, the request analyzer 1000 can receive a request from the EIO 935 to add the service 922 to the data lake region A 917A. In such examples, the request includes a service ID 937 of the service 922 and a data lake region ID 936 corresponding to the data lake region A 917A. In response to the request analyzer 1000 receiving the request, the service authorizer 1004 can determine whether the service 922 is authorized to access the data lake region A 917A. For example, the service authorizer 1004 determines whether the service 922 is granted access and/or determines the level of access granted to the service 922 based on attestations implemented by the NIC 920.

In some examples, the NIC 920 can generate a voucher (e.g., an RFC8366 voucher) that identifies entities that own the data lake region A 917A. A different voucher can be used to identify entities that can read and modify data, and/or entities that can read but not modify the data. For example, the NIC 920 provides the voucher to a participating entity (e.g., the service 922) in response to the request from the EIO 935.

In some examples, the data lake table 934 includes a label for each of the service IDs 937 to indicate the level of access granted to the service 922 for the data lake region A 917A. For example, the data lake table 934 can include a first label to indicate that the service 922 can read data from the data lake region A 917A, a second label to indicate that the service 922 can write data to the data lake region A 917A, and/or a third label to indicate that the service 922 can modify data of the data lake region A 917A.

In response to the service authorizer 1004 determining that the service 922 is authorized, the data lake table controller 1012 obtains the RDEK corresponding to the data lake region A 917A from the data lake table 934. The key distributor 1008 sends the RDEK to the edge device hosting the service 922 (e.g., the third edge platform 906). In some examples, the key generator 1006 generates a KWK corresponding to the service 922, and the key distributor 1008 uses the KWK to wrap the RDEK prior to sending the RDEK to the service 922. In such examples, the key distributor 1008 sends both the wrapped RDEK and the KWK to the service 922 and/or to the third edge platform 906. In some examples, the data lake table controller 1012 updates an entry of the data lake table 934 corresponding to the data lake region A 917A to include the service ID 937 of the service 922.

In some examples, the data lake manager 908 can remove a service (e.g., the service 922) from a data lake region (e.g., the data lake region A 917A). For example, the request analyzer 1000 receives a request from the EIO 935 to remove the service 922 from the data lake region A 917A. Of course, after a service is removed, a concern remains that devices previously using that service will still have access to the data lake and/or data lake region. To address such concerns, and in response to the request analyzer 1000 receiving the request to remove the service 922, the key generator 1006 generates a new RDEK for the data lake region A 917A from which the service 922 is to be removed. The key distributor 1008 sends the new RDEK to each service currently participating in the data lake region A 917A, except for the service 922 being removed. In some examples, the instruction transmitter 1014 notifies the participating services to temporarily suspend accessing the data lake region A 917A. In response to the participating services suspending access, the key distributor 1008 sends the new RDEK to each edge storage device storing the data lake region A917A (e.g., the second edge platform 904).

The secondary manager A 912A of the second edge platform 904, upon receiving the new RDEK, decrypts data from the data lake region A 917A using a current RDEK corresponding to the data lake region A 917A, and re-encrypts the data using the new RDEK In such examples, the data from the data lake region A 917A can no longer be decrypted using the old RDEK and, thus, the service 922 that has been removed is prevented from reading from and/or writing to the data lake region A 917A. Upon re-encryption of the data using the new RDEK, the instruction transmitter 1014 notifies the participating services that accessing of the data lake region A 917A may be resumed. In some examples, the data lake table controller 1012 removes the service ID 937 of the service 922 from the entry of the data lake table 934 corresponding to the data lake region A 917A.

In the illustrated example of FIG. 9, the secondary manager 912 of FIG. 11 (e.g., the secondary manager A 912A and/or the secondary manager B 912B) is implemented at each of the second edge platform 904 and the third edge platform 906 to provide access to the data lake 915 by one or more services (e.g., the service 922). For example, the secondary manager 912 allows the service 922 to read data from a data lake region (e.g., the data lake region A 917A). In one example, the service 922 sends a request to the instruction analyzer 1100 of FIG. 11 to read data from the data lake region A 917A, where the request includes the data lake region ID 936 corresponding to the data lake region A 917A and the service ID 937 of the service 922.

In response to the instruction analyzer 1100 receiving the request, the service identifier 1102 of FIG. 11 determines whether the service 922 is authorized to read from the data lake region A 917A. For example, the service identifier 1102 identifies the entry of the data table corresponding to the data lake region A 917A, and determines that the service 922 is authorized to read from the data lake region A 917A in response to determining that the entry includes the service ID 937 of the service 922 and/or includes a label indicating an authorization to read data. The data retriever 1104 of FIG. 11 retrieves the data from the data lake region A 917A based on the location (e.g., the data lake storage nodes 940 and the address range 942) identified in the entry of the data lake table 934. The key manager 1106 of FIG. 11 obtains the RDEK corresponding to the data lake region A 917A from the entry of the data lake table 934. The data decryptor 1110 of FIG. 11 receives the data from the data retriever 1104 and receives the RDEK from the key manager 1106, then decrypts the data using the RDEK. In response to the data decryptor 1110 decrypting the data, the data transmitter 1112 of FIG. 11 transmits the decrypted data to the service 922 for reading. Additionally or alternatively, in response to the service identifier 1102 determining that the service 922 has homomorphic access to the data lake region A 917A, the example data decryptor 1110 can decrypt the data using the homomorphic encryption key from the key manager 1106.

In some examples, the secondary manager 912 allows the service 922 to write new data to the data lake region A 917A. In one example, the service 922 sends a request to the instruction analyzer 1100 to write new data to the data lake region A 917A, where the request includes the data lake region ID 936 corresponding to the data lake region A 917A, the service ID 937 of the service 922, and unencrypted new data written by the service 922. In response to the instruction analyzer 1100 receiving the request, the service identifier 1102 determines whether the service 922 is authorized to write to the data lake region A 917A. For example, the service identifier 1102 identifies the entry of the data table corresponding to the data lake region A 917A, and determines that the service 922 is authorized to write to the data lake region A 917A in response to determining that the entry includes the service ID 937 of the service 922 and/or includes a label indicating an authorization to write data. The key manager 1106 obtains the RDEK corresponding to the data lake region A 917A from the entry of the data lake table 934. The data encryptor 1108 receives the unencrypted new data from the instruction analyzer 1100 and receives the RDEK from the key manager 1106, then encrypts the new data using the RDEK. The data transmitter 1112 then transmits the encrypted new data to the data lake region A 917A for storage. Additionally or alternatively, in response to the example service identifier 1102 determining that the service 922 has homomorphic access to the data lake region A 917A, the example data encryptor 1108 can encrypt the data using the homomorphic encryption key from the key manager 1106.

Flowcharts representative of example hardware logic, machine readable instructions, hardware implemented state machines, and/or any combination thereof for implementing the data lake manager 908 and/or the secondary manager 912 of FIG. 9 is shown in FIGS. 12, 13, 14, 15, 16, 17 and/or 18. The machine readable instructions may be one or more executable programs or portion(s) of an executable program for execution by a computer processor and/or processor circuitry, such as the processor 752 shown in the example processor platform 750 discussed above in connection with FIG. 7B. The program may be embodied in software stored on a non-transitory computer readable storage medium such as a CD-ROM, a floppy disk, a hard drive, a DVD, a Blu-ray disk, or a memory associated with the processor 752, but the entire program and/or parts thereof could alternatively be executed by a device other than the processor 752 and/or embodied in firmware or dedicated hardware. Further, although the example program is described with reference to the flowchart illustrated in FIGS. 12, 13, 14, 15, 16, 17 and/or 18, many other methods of implementing the example data lake manager 908 and/or the secondary manager 912 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 12, 13, 14, 15, 16, 17 and/or 18 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 12 is a flowchart representative of machine readable instructions 1200 which may be executed to implement the example data lake manager 908 of FIGS. 9 and/or 10 to manage the data lakes registry architecture 900 of FIG. 9. The example instructions 1200 of FIG. 12 begin as the example data lake manager 908 is installed in and/or invoked by the first edge platform 902 of FIG. 9 by the EIO 935.

At block 1202, the example data lake manager 908 determines whether to create a data lake region. For example, in response to the request analyzer 1000 receiving a request from the EIO 935 of FIG. 9 to create a data lake region (e.g., block 1202 returns a result of YES), the process 1200 proceeds to block 1204. Alternatively, in response to the example request analyzer 1000 not receiving the request from the EIO 935 to create a data lake region (e.g., block 1202 returns a result of NO), the process 1200 proceeds to block 1206.

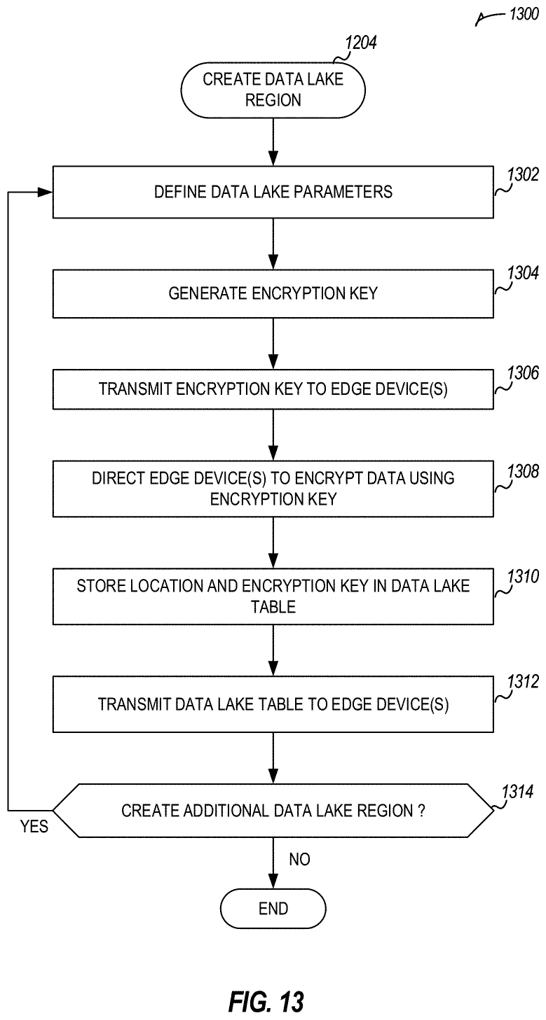

At block 1204, the example data lake manager 908 creates a data lake region as described in connection with FIG. 13 below.

At block 1206, the example data lake manager 908 determines whether to remove a data lake region in the data lakes registry architecture 900. For example, in response to the request analyzer 1000 receiving a request from the EIO 935 to remove a data lake region (e.g., block 1206 returns a result of YES), the process 1200 proceeds to block 1208. Alternatively, in response to the example request analyzer 1000 not receiving a request from the EIO 935 to remove a data lake region (e.g., block 1206 returns a result of NO), the process 1200 proceeds to block 1210.

At block 1208, the example data lake manager 908 removes a data lake region as described in connection with FIG. 14 below.

At block 1210, the example data lake manager 908 determines whether to add a service (e.g., the service 922 of FIG. 9) to a data lake region in the data lakes registry architecture 900. For example, in response to the request analyzer 1000 receiving a request from the EIO 935 to add a service to a data lake region (e.g., block 1210 returns a result of YES), the process 1200 proceeds to block 1212. Alternatively, in response to the example request analyzer 1000 not receiving a request from the EIO 935 to add a service to a data lake region (e.g., block 1210 returns a result of NO), the process 1200 proceeds to block 1214.

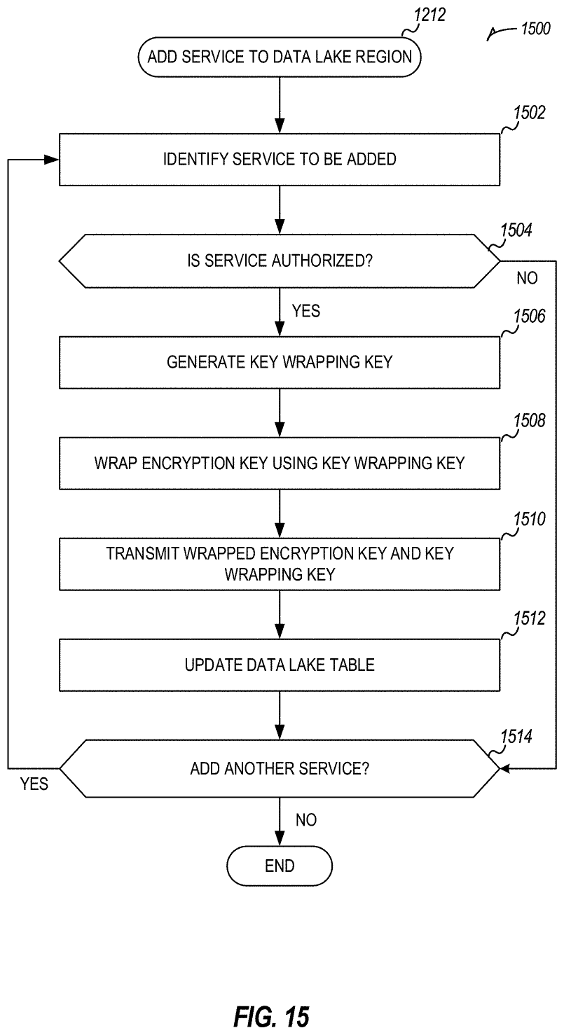

At block 1212, the example data lake manager 908 adds a service to a data lake region as described in connection with FIG. 15 below.

At block 1214, the example data lake manager 908 determines whether to remove a service from a data lake region. For example, in response to the request analyzer 1000 receiving a request from the EIO 935 to remove a service from a data lake region (e.g., block 1214 returns a result of YES), the process 1200 proceeds to block 1216. Alternatively, in response to the example request analyzer 1000 not receiving a request from the EIO 935 to remove a service from a data lake region (e.g., block 1214 returns a result of NO), the process 1200 proceeds to block 1218.

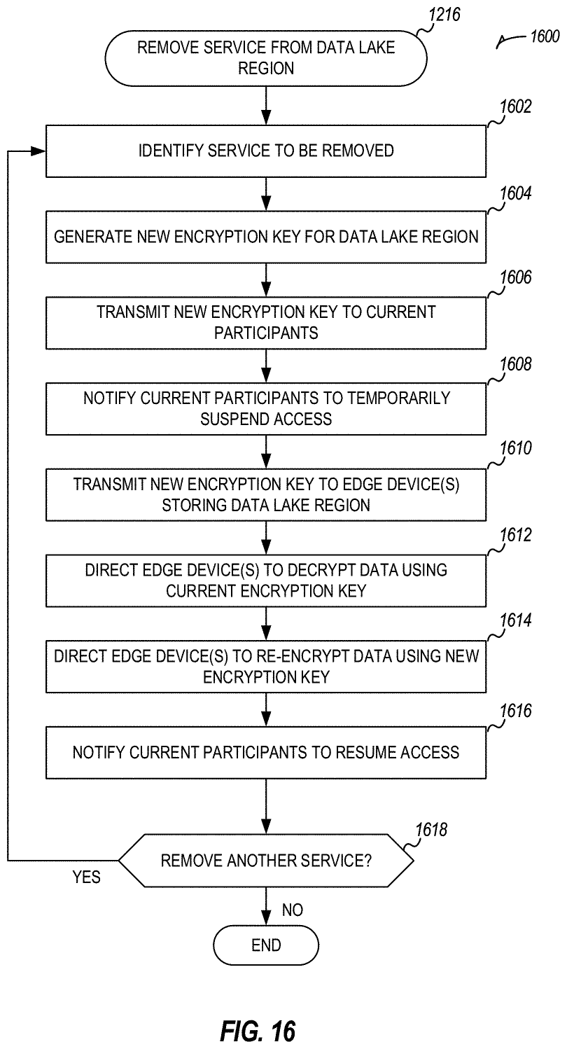

At block 1216, the example data lake manager 908 removes a service from a data lake region as described in connection with FIG. 16 below.

At block 1218, the example data lake manager 908 determines whether to continue monitoring the data lakes registry architecture 900. For example, in response to the request analyzer 1000 determining to continue monitoring the data lakes registry architecture 900 based on receiving another request from the EIO 935 (e.g., block 1218 returns a result of YES), the process 1200 returns to block 1202. Alternatively, in response to the example request analyzer 1000 determining not to continue monitoring the data lakes registry architecture 900 based on not receiving another request from the EIO 935 (e.g., block 1218 returns a result of NO), the process 1200 ends.

FIG. 13 is a flowchart representative of machine readable instructions 1300 which may be executed to implement the example data lake manager of FIGS. 9 and/or 10 to create a new data lake region (e.g., the data lake region A 917A and/or the data lake region B 917B) in association with block 1304 of FIG. 11. The instructions 1300 begin as the example request analyzer 1000 of the example data lake manager 908 receives a request from the EIO 935 to create a new data lake region.

At block 1302, the example data lake manager 908 defines data lake region parameters for the new data lake region. For example, the location selector 1002 of FIG. 10 defines the data lake region parameters including a data lake region ID 936 corresponding to the new data lake region, one or more data lake storage nodes 940 to store the new data lake region, and an address range 942 defining a storage location within the one or more data lake storage nodes 940. In the illustrated example of FIG. 9, the one or more data lake storage nodes 940 include the second edge platform 904, and the address range 942 is a location within the storage 914.

At block 1304, the example data lake manager 908 generates an encryption key corresponding to the new data lake region. For example, the key generator 1006 of FIG. 10 generates an RDEK corresponding to the new data lake region. In some examples, the key generator 1006 also generates a KWK for wrapping the RDEK.

At block 1306, the example data lake manager 908 transmits the encryption key to the one or more edge devices storing the new data lake region. For example, the key distributor 1008 transmits the RDEK to the one or more data lake storage nodes 940 defined by the location selector 1002. In some examples, the key distributor 1008 also transmits the KWK corresponding to the RDEK. In such examples, the key distributor 1008 wraps the RDEK using the KWK prior to transmitting both the RDEK and the KWK to the one or more edge devices.

At block 1308, the example data lake manager 908 directs the one or more edge devices to encrypt data of the new data lake region using the encryption key. For example, the instruction transmitter 1014 sends instructions to the secondary manager A 912A of the second edge platform 904 to encrypt the data using the RDEK. In some examples, the data retriever 1104 of FIG. 11 retrieves data from the location of the new data lake region defined by the location selector 1002. The data encryptor 1108 of FIG. 11 encrypts the data using the RDEK. In some examples, the key manager 1106 of FIG. 11 unwraps the RDEK using the KWK prior to the data encryptor 1108 encrypting the data. In some examples, the data transmitter 1112 of FIG. 11 transmits the encrypted data for storage in the new data lake region.

At block 1310, the example data lake manager 908 stores the location and the encryption key corresponding to the new data lake region in the data lake table 934 of FIG. 9. For example, the data lake table controller 1012 generates a new entry of the data lake table 934 corresponding to the new data lake region, where the new entry includes the data lake parameters (e.g., the data lake region ID 936, the one or more data lake storage nodes 940, and the address range 942) defined at block 1302 and the RDEK generated at block 1304.

At block 1312, the example data lake manager 908 transmits the data lake table 934 to the one or more edge devices. For example, the data lake table controller 1012 transmits a copy of the data lake table 934 or a portion (e.g., the first portion 934A and/or the second portion 934B) of the data lake table 934 to the one or more edge devices (e.g., the second edge platform 904) storing the new data lake region.

At block 1314, the example data lake manager 908 determines whether to create an additional data lake region. For example, in response to the request analyzer 1000 receiving another request from the EIO 935 that another data lake region is to be created (block 1314 returns a result of YES), the process 1300 returns to block 1302. Alternatively, in response to the request analyzer 1000 not receiving another request from the EIO 935 that another data lake region is to be created (block 1314 returns a result of NO), the process 1300 ends.

FIG. 14 is a flowchart representative of machine readable instructions 1400 which may be executed to implement the example data lake manager of FIGS. 9 and/or 10 to remove a data lake region in association with block 1208 of FIG. 12. The instructions 1400 begin as the example request analyzer 1000 of the example data lake manager 908 receives a request from the EIO 935 to remove a data lake region (e.g., the data lake region A 917A of FIG. 9) from the data lakes registry architecture 900 of FIG. 9.

At block 1402, the example data lake manager 908 determines whether the data lake region A 917A has expired. For example, the timing controller 1010 determines that the data lake region A 917A has expired in response to determining that a duration of time has passed since creation of the data lake region A 917A. In such examples, the duration of time is determined by the timing controller 1010 upon the data lake region A 917A being created. In response to the timing controller 1010 of FIG. 10 determining that the data lake region A 917A has expired (block 1402 returns a result of YES), the process 1400 proceeds to block 1404. Alternatively, in response to the timing controller 1010 determining that the data lake region A 917A has not expired (block 1402 returns a result of NO), the process 1400 ends.

At block 1404, the example data lake manager 908 notifies participating tenants that the data lake region A 917A is to be removed. For example, the instruction transmitter 1014 notifies the one or more services (e.g., the service 922 of FIG. 9) currently having access to the data lake region A 917A via a message to one or more edge devices hosting the service 922. In some examples, the message can include at least one of the data lake region ID 936 of the data lake region A 917A to be removed and/or the time at which the data lake region A 917A is to be removed.

At block 1406, the example data lake manager 908 directs one or more edge devices storing the data lake region A 917A to remove data from the data lake region. For example, the instruction transmitter 1014 sends instructions to the example secondary manager A 912A to delete the data of the data lake region A 917A and/or move the data to a different location of the second edge platform 904. In some examples, the data is not deleted and the example secondary manager A 912A is instead directed to overwrite the data with new data.

At block 1408, the example data lake manager 908 deletes encryption keys corresponding to the removed data lake region A 917A. For example, the instruction transmitter 1014 directs the secondary manager A 912A to delete an RDEK corresponding to the removed data lake region A 917A. Additionally, in some examples, the data lake table controller 1012 deletes an entry in the data lake table 934 of FIG. 9 corresponding to the data lake region A 917A. The process 1400 ends.

FIG. 15 is a flowchart representative of machine readable instructions 1500 which may be executed to implement the example data lake manager of FIGS. 9 and/or 10 to add a service (e.g., the service 922 of FIG. 9) to a data lake region (e.g., the data lake region A 917A of FIG. 9) in association with block 1212 of FIG. 12. The instructions 1500 begin as the example request analyzer 1000 of the example data lake manager 908 receives a request from the EIO 935 to add the service 922 to the data lake region A 917A of the data lakes registry architecture 900 of FIG. 9.

At block 1502, the example data lake manager 908 identifies the service to be added. For example, the service authorizer 1004 of FIG. 10 identifies the service ID 937 and/or credentials of the service 922 to be added based on the request received from the EIO 935.

At block 1504, the example data lake manager 908 determines whether the service 922 is authorized to access the data lake region A 917A. For example, the service authorizer 1004 determines whether the service 922 is authorized based on the credentials of the service 922. In some examples, the service authorizer 1004 uses a voucher (e.g., an RFC8366) corresponding to the service to determine that the service 922 is authorized. In some examples, the service authorizer 1004 determines whether the service 922 is authorized to at least one of read from, write to, or modify the data lake region A 917A. In some examples, the service authorizer 1004 assigns a label to the service 922 to indicate the level of access granted to the service 922. In response to the example service authorizer 1004 determining that the service 922 is authorized (block 1504 returns a result of YES), the process 1500 proceeds to block 1506. Alternatively, in response to the example service authorizer 1004 determining that the service 922 is not authorized (block 1504 returns a result of NO), the process 1500 proceeds to block 1514.

At block 1506, the example data lake manager 908 generates a key wrapping key (KWK). For example, the key generator 1006 of FIG. 10 generates the KWK corresponding to the service 922 and/or the tenant hosting the service 922.

At block 1508, the example data lake manager 908 wraps an encryption key corresponding to the data lake region using the KWK generated by the key generator 1006. For example, the key distributor 1008 of FIG. 10 obtains an RDEK corresponding to the data lake region A 917A, then wraps the RDEK using the KWK. In such examples, the key distributor 1008 obtains the RDEK from an entry of the data lake table 934 corresponding to the data lake region A 917A.

At block 1510, the example data lake manager 908 transmits the wrapped encryption key and the KWK to one or more edge devices. For example, the key distributor 1008 identifies the one or more edge devices (e.g., the second edge platform 904) storing the data lake region A 917A from the entry of the data lake table 934, then transmits the wrapped RDEK and the KWK to the one or more edge devices. Additionally or alternatively, the example key distributor 1008 transmits the wrapped RDEK and the KWK to the service 922 and/or one or more edge devices hosting the service 922 (e.g., the third edge platform 906). In some examples, the key distributor 1008 can additionally or alternatively transmit a homomorphic encryption key corresponding to the data lake region A 917A to the one or more edge devices and/or to the service 922.

At block 1512, the example data lake manager 908 updates the data lake table 934. For example, the data lake table controller 1012 of FIG. 10 updates the entry of the data lake table 934 corresponding to the data lake region A 917A. In some examples, the entry of the data lake table 934 is updated to include the service ID 937 corresponding to the service 922.

At block 1514, the example data lake manager 908 determines whether another service is to be added to the data lakes registry architecture 900. For example, in response to the request analyzer 1000 receiving another request from the EIO 935 to add another service (block 1514 returns a result of YES), the process 1500 returns to block 1502. Alternatively, in response to the example request analyzer 1000 not receiving another request from the EIO 935 to add another service (block 1514 returns a result of NO), the process 1500 ends.

FIG. 16 is a flowchart representative of machine readable instructions 1600 which may be executed to implement the example data lake manager 908 of FIGS. 9 and/or 10 to remove a service (e.g., the service 922 of FIG. 9) from a data lake region (e.g., the data lake region A 917A of FIG. 9) in association with block 1216 of FIG. 12. The instructions 1600 begin as the example request analyzer 1000 of FIG. 10 receives a request from the EIO 935 to remove the service 922 from the data lake region A 917A.

At block 1602, the example data lake manager 908 identifies the service 922 to be removed. For example, the service authorizer 1004 of FIG. 10 identifies a service ID 937 corresponding to the service 922 based on the request received from the EIO 935. In some examples, the service authorizer 1004 identifies a data lake region ID 936 corresponding to the data lake region A 917A.

At block 1604, the example data lake manager 908 generates a new encryption key for the data lake region A 917A. For example, the key generator 1006 generates a new RDEK corresponding to the data lake region A 917A, where the new RDEK is different from a current RDEK corresponding to the data lake region A 917A.

At block 1606, the example data lake manager 908 transmits the new encryption key to current participants of the data lake region A 917A. For example, the key distributor 1008 transmits the new RDEK to one or more services currently having access to the data lake region A 917A, and to one or more edge devices (e.g., the second edge platform 904) storing the data lake region A 917A. In such examples, the key distributor 1008 does not transmit the new RDEK to the service 922.

At block 1608, the example data lake manager 908 notifies the current participants to temporarily suspend access to the data lake region A 917A. For example, the instruction transmitter 1014 sends a message to the one or more services currently having access to the data lake region A 917A to temporarily suspend accessing the data lake region A 917A. In some examples, the instruction transmitter 1014 notifies the one or more edge devices (e.g., the second edge platform 904) storing the data lake region A 917A to temporarily prevent accesses to the data lake region A 917A.

At block 1610, the example data lake manager 908 transmits the new encryption key to the one or more edge devices storing the data lake region A 917A. For example, the key distributor 1008 transmits the new RDEK to the one or more edge devices storing the data lake region A 917A (e.g., the second edge platform 904), and to the one or more services currently having access to the data lake region A 917A. In some examples, the one or more edge devices install the new RDEK in an accelerator (e.g., the first accelerator 910 and/or the second accelerator 916 of FIG. 9) to increase speed of encryption and decryption.

At block 1612, the example data lake manager 908 directs the one or more edge devices to decrypt data using the current encryption key. For example, the instruction transmitter 1014 sends instructions to the instruction analyzer 1100 of FIG. 11 to decrypt the data. In such examples, the data retriever 1104 retrieves data from the data lake region A 917A, where the data retriever 1104 determines the location of the data based on the data lake table 934 and the data lake region ID 936 identified in block 1602. The example key manager 1106 of FIG. 11 obtains the current RDEK corresponding to the data lake region A 917A from the data lake table 934, and the example data decryptor 1110 of FIG. 11 decrypts the data using the current RDEK.

At block 1614, the example data lake manager 908 directs the one or more edge devices to re-encrypt the data using the new encryption key. For example, instruction transmitter 1014 sends instructions to the instruction analyzer 1100 to re-encrypt the data using the new RDEK generated at block 1504. In such examples, the data encryptor 1108 of FIG. 11 encrypts the data using the new RDEK, and the data transmitter 1112 of FIG. 11 transmits the encrypted data for storage at the location defining the data lake region A 917A.

At block 1616, the example data lake manager 908 notifies the current participants to resume accessing the data lake region A 917A. For example, the instruction transmitter 1014 notifies via a message to the one or more services currently having access to the data lake region A 917A that accessing the data lake region A 917A may be resumed using the new RDEK. Additionally or alternatively, the example instruction transmitter 1014 sends the message to one or more edge storage locations storing the data lake region A 917A to resume allowing accesses to the data lake region A 917A.

At block 1618, the example data lake manager 908 determines whether another service is to be removed from the data lakes registry architecture 900. For example, in response to the request analyzer 1000 receiving another request from the EIO 935 to remove another service (block 1618 returns a result of YES), the process 1600 returns to block 1602. Alternatively, in response to the example request analyzer 1000 not receiving another request from the EIO 935 to remove another service (block 1618 returns a result of NO), the process 1600 ends.

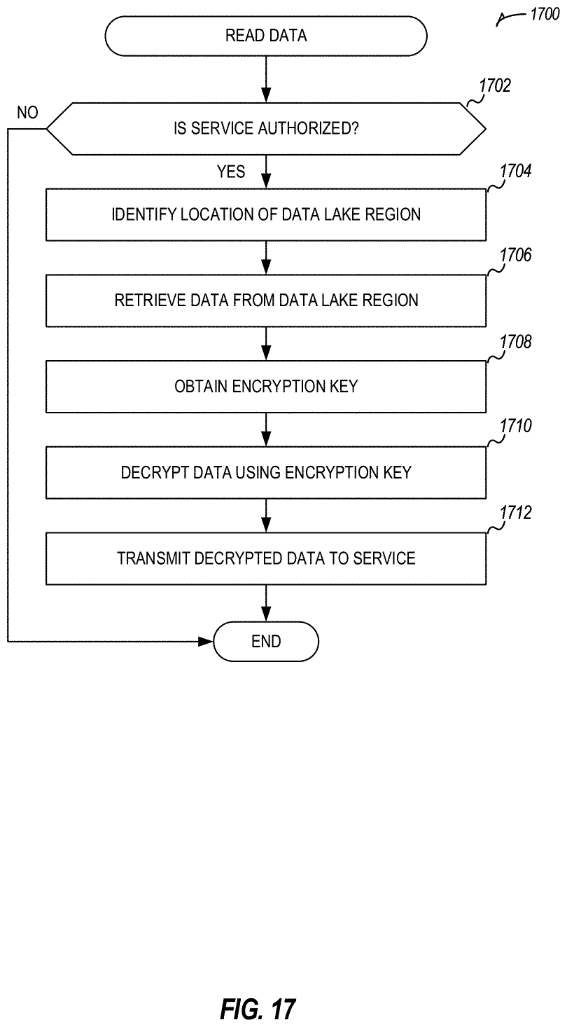

FIG. 17 is a flowchart representative of machine readable instructions 1700 which may be executed to implement the example secondary manager 912 of FIGS. 9 and/or 11 to read data from a data lake region (e.g., the data lake region A 917A of FIG. 9) to a service (e.g., the service 922 of FIG. 9). The instructions 1700 begin as the example instruction analyzer 1100 of FIG. 11 receives a request from the service 922 to read data from the data lake region A 917A. In some examples, the instruction analyzer 1100 obtains from the request the service ID 937 corresponding to the service 922 and the data lake region ID 936 corresponding to the data lake region A 917A.

At block 1702, the example secondary manager 912 determines whether the service 922 is authorized to read data from the data lake region A 917A. For example, the service identifier 1102 of FIG. 11 identifies an entry of the data lake table 934 corresponding to the data lake region A 917A based on the data lake region ID 936 obtained from the request. The example service identifier 1102 determines whether the entry of the data lake table 934 includes the service ID 937 corresponding to the service 922 and/or a label indication authorization to read data from the data lake region A 917A. In response to the example service identifier 1102 determining that the service 922 is authorized to read data from the data lake region A 917A (e.g., block 1702 returns a result of YES), the process 1700 proceeds to block 1704. Alternatively, in response to the example service identifier 1102 determining that the service 922 is not authorized to read data from the data lake region A 917A (e.g., block 1702 returns a result of NO), the process 1700 ends.

At block 1704, the example secondary manager 912 identifies a location of the data lake region A 917A. For example, the data retriever 1104 of FIG. 11 identifies the data lake storage nodes 940 and the address range 942 corresponding to the data lake region A 917A based on the entry of the data lake table 934.

At block 1706, the example secondary manager 912 retrieves data from the data lake region A 917A. For example, the data retriever 1104 retrieves the data stored at the location (e.g., the data lake storage nodes 940 and the address range 942 corresponding to the data lake region A 917A) identified at block 1704. In some examples, the data is encrypted data.

At block 1708, the example secondary manager 912 obtains an encryption key corresponding to the data lake region A 917A. For example, the key manager 1106 of FIG. 11 obtains an RDEK corresponding to the data lake region A 917A from the entry of the data lake table 934. Additionally or alternatively, the example key manager 1106 obtains a homomorphic encryption key corresponding to the data lake region A 917A.

At block 1710, the example secondary manager 912 decrypts the data from the data lake region A 917A using the encryption key. For example, the data decryptor 1110 of FIG. 11 receives the RDEK from the key manager 1106, then decrypts the data retrieved by the data retriever 1104 using the RDEK. Additionally or alternatively, the example data decryptor 1110 decrypts the data using the homomorphic encryption key corresponding to the data lake region A 917A.

At block 1712, the example secondary manager 912 transmits the decrypted data to the service 922. For example, the data transmitter 1112 of FIG. 11 transmits the decrypted data to the service 922 for reading the data. Additionally or alternatively, the example data transmitter 1112 can transmit the encrypted data to the service 922, so that decryption of the data is performed by the service 922 instead of the secondary manager 912. The process 1700 ends.

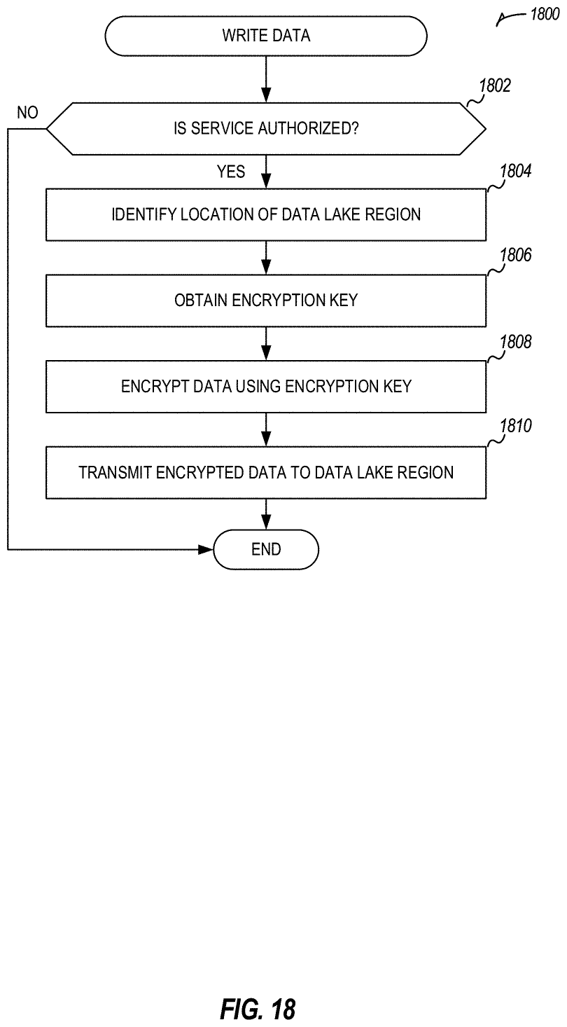

FIG. 18 is a flowchart representative of machine readable instructions 1800 which may be executed to implement the example secondary manager 912 of FIGS. 9 and/or 11 to write data to a data lake region (e.g., the data lake region A 917A of FIG. 9) from a service (e.g., the service 922 of FIG. 9). The instructions 1800 begin as the example instruction analyzer 1100 of FIG. 11 receives a request from the service 922 to write data to the data lake region A 917A. In some examples, the instruction analyzer 1100 obtains from the request the service ID 937 corresponding to the service 922, the data lake region ID 936 corresponding to the data lake region A 917A, and unencrypted data written by the service 922. In some examples, the service 922 encrypts the written data prior to sending the data to the instruction analyzer 1100.

At block 1802, the example secondary manager 912 determines whether the service 922 is authorized to write data to the data lake region A 917A. For example, the service identifier 1102 of FIG. 11 identifies an entry of the data lake table 934 corresponding to the data lake region A 917A based on the data lake region ID 936 obtained from the request. The example service identifier 1102 determines whether the entry of the data lake table 934 includes the service ID 937 corresponding to the service 922 and/or a label indication authorization to write data to the data lake region A 917A. In response to the example service identifier 1102 determining that the service 922 is authorized to write data to the data lake region A 917A (e.g., block 1802 returns a result of YES), the process 1800 proceeds to block 1804. Alternatively, in response to the example service identifier 1102 determining that the service 922 is not authorized to write data to the data lake region A 917A (e.g., block 1802 returns a result of NO), the process 1800 ends.

At block 1804, the example secondary manager 912 identifies a location of the data lake region A 917A. For example, the data retriever 1104 of FIG. 11 identifies the data lake storage nodes 940 and the address range 942 corresponding to the data lake region A 917A based on the entry of the data lake table 934.

At block 1806, the example secondary manager 912 obtains an encryption key corresponding to the data lake region A 917A. For example, the key manager 1106 of FIG. 11 obtains an RDEK corresponding to the data lake region A 917A from the entry of the data lake table 934. Additionally or alternatively, the example key manager 1106 obtains a homomorphic encryption key corresponding to the data lake region A 917A.

At block 1808, the example secondary manager 912 encrypts the unencrypted data written by the service 922 using the encryption key. For example, the data encryptor 1108 of FIG. 11 receives the RDEK from the key manager 1106 and the unencrypted data from the instruction analyzer 1100, then encrypts the data using the RDEK. Additionally or alternatively, the example data encryptor 1108 encrypts the data using the homomorphic encryption key corresponding to the data lake region A 917A.

At block 1810, the example secondary manager 912 transmits the encrypted data to the data lake region A 917A for storage. For example, the data transmitter 1112 of FIG. 11 transmits the encrypted data to the data lake region A 917A based on the location identified by the data retriever 1104 at block 1804. The process 1800 ends.

From the foregoing, it will be appreciated that example methods, apparatus and articles of manufacture have been disclosed that improve the static nature of existing data lake management techniques. Unlike such static data lake techniques, examples disclosed herein dynamically create, remove, and/or modify data lakes stored in a scalable multi-tiered edge environment and manage secure accesses to the data lakes. Disclosed methods, apparatus and articles of manufacture improve the efficiency of using a computing device by dynamically partitioning the data lakes into a number of data lake regions with varying size and duration. As such, data lakes can be modified by adding or removing individual data lake regions, thereby reducing the time and computing costs (e.g., computational demands on processors, bandwidth demands, etc.) required for encryption and re-encryption of entire data lakes. Further, example methods, apparatus and articles of manufacture disclosed herein improve data security by encrypting data using region-specific encryption keys, thereby preventing access to the data by unauthorized entities. Disclosed methods, apparatus and articles of manufacture are accordingly directed to one or more improvement(s) in the functioning of a computer.

The following claims are hereby incorporated into this Detailed Description by this reference, with each claim standing on its own as a separate embodiment of the present disclosure.

Example methods, apparatus, systems, and articles of manufacture to manage access to decentralized data lakes are disclosed herein. Further examples and combinations thereof include the following: Example 1 includes an apparatus to manage a data lake. The example apparatus includes a location selector to select an edge device to store the data lake, a key generator to, in response to an indication that a service is authorized to access the data lake, generate an encryption key corresponding to the data lake and generate a key wrapping key corresponding to the edge device, and a key distributor to wrap the encryption key using the key wrapping key and distribute the encryption key and the key wrapping key to the edge device, the encryption key to enable the service on the edge device to access the data lake.

Example 2 includes the apparatus of Example 1, where the edge device is a first edge device, the data lake including a first data lake region and a second data lake region, the first data lake region stored on the first edge device, and the second data lake region stored on at least one of the first edge device or a second edge device.

Example 3 includes the subject matter of any one or more of Examples 1 and/or 2 and optionally includes a data lake table controller to generate a data lake table, where an entry of the data lake table includes at least one of a data lake ID corresponding to the data lake, a service ID corresponding to the service, the encryption key, an edge device identifier corresponding to the edge device, or an address range of the data lake in the edge device.

Example 4 includes the subject matter of any one or more of Examples 1-3 and optionally includes a service authorizer to determine whether the service is authorized to access the data lake, the data lake table controller to update the entry of the data lake table based on a result of the determination.

Example 5 includes the subject matter of any one or more of Examples 1-4 and optionally the encryption key is a first encryption key, and where the service authorizer is to determine that the service is no longer authorized to access the data lake, the key generator is to generate a second encryption key different from the first encryption key, the key distributor is to distribute the second encryption key to the edge device, direct the edge device to decrypt data from the data lake using the first encryption key, and direct the edge device to re-encrypt the data using the second encryption key, and the data lake table controller is to remove the first encryption key and the service identifier from the entry of the data lake table and add the second encryption key to the entry of the data lake table.

Example 6 includes the subject matter of any one or more of Examples 1-5 and optionally the edge device is to unwrap the encryption key using the key wrapping key, decrypt existing data from the data lake using the encryption key, encrypt new data written by the service using the encryption key, and store the new data in the data lake.

Example 7 includes the subject matter of any one or more of Examples 1-6 and optionally includes a timing controller to determine whether the data lake has expired based on a duration of time and, in response to determining that the data lake has expired, direct the edge device to delete the encryption key and data from the data lake.

Example 8 includes a method to manage a data lake. The example method includes selecting an edge device to store the data lake, in response to an indication that a service is authorized to access the data lake, generating an encryption key corresponding to the data lake and generating a key wrapping key corresponding to the edge device, wrapping the encryption key using the key wrapping key, and distributing the encryption key and the key wrapping key to the edge device, the encryption key to enable the service on the edge device to access the data lake.

Example 9 includes the method of Example 8, where the edge device is a first edge device, the data lake including a first data lake region and a second data lake region, the first data lake region stored on the first edge device, and the second data lake region stored on at least one of the first edge device or a second edge device.

Example 10 includes the subject matter of any one or more of Examples 8 and/or 9 and optionally includes generating a data lake table, where an entry of the data lake table includes at least one of a data lake ID corresponding to the data lake, a service ID corresponding to the service, the encryption key, an edge device identifier corresponding to the edge device, and an address range of the data lake in the edge device.

Example 11 includes the subject matter of any one or more of Examples 8-10 and optionally includes determining whether the service is authorized to access the data lake, and updating the entry of the data lake table based on a result of the determination.

Example 12 includes the subject matter of any one or more of Examples 8-11 and optionally the encryption key is a first encryption key, and further includes determining that the service is no longer authorized to access the data lake, generating a second encryption key different from the first encryption key, distributing the second encryption key to the edge device, directing the edge device to decrypt data from the data lake using the first encryption key, directing the edge device to re-encrypt the data using the second encryption key, removing the first encryption key and the service identifier from the entry of the data lake table, and adding the second encryption key to the entry of the data lake table.

Example 13 includes the subject matter of any one or more of Examples 8-12 and optionally includes unwrapping the encryption key using the key wrapping key, decrypting existing data from the data lake using the encryption key, encrypting new data written by the service using the encryption key, and storing the new data in the data lake.

Example 14 includes the subject matter of any one or more of Examples 8-13 and optionally includes determining whether the data lake has expired based on a duration of time and, in response to determining that the data lake has expired, directing the edge device to delete the encryption key and data from the data lake.

Example 15 includes a non-transitory computer readable storage medium comprising instructions that, when executed, cause a processor to at least select an edge device to store a data lake, in response to an indication that a service is authorized to access the data lake, generate an encryption key corresponding to the data lake and generate a key wrapping key corresponding to the edge device, wrap the encryption key using the key wrapping key, and distribute the encryption key and the key wrapping key to the edge device, the encryption key to enable the service on the edge device to access the data lake.

Example 16 includes the non-transitory computer readable storage medium of Example 15, where the edge device is a first edge device, the data lake including a first data lake region and a second data lake region, the first data lake region stored on the first edge device, and the second data lake region stored on at least one of the first edge device or a second edge device.

Example 17 includes the subject matter of any one or more of Examples 15 and/or 16 and optionally the instructions, when executed, cause the processor to generate a data lake table, where an entry of the data lake table includes at least one of a data lake ID corresponding to the data lake, a service ID corresponding to the service, the encryption key, an edge device identifier corresponding to the edge device, and an address range of the data lake in the edge device.

Example 18 includes the subject matter of any one or more of Examples 15-17 and optionally the instructions, when executed, cause the processor to determine whether the service is authorized to access the data lake, and update the entry of the data lake table based on a result of the determination.

Example 19 includes the subject matter of any one or more of Examples 15-18 and optionally the encryption key is a first encryption key, and where the instructions, when executed, cause the processor to determine that the service is no longer authorized to access the data lake, generate a second encryption key different from the first encryption key, distribute the second encryption key to the edge device, direct the edge device to decrypt data from the data lake using the first encryption key, direct the edge device to re-encrypt the data using the second encryption key, remove the first encryption key and the service identifier from the entry of the data lake table, and add the second encryption key to the entry of the data lake table.

Example 20 includes the subject matter of any one or more of Examples 15-19 and optionally the instructions, when executed, cause the processor to unwrap the encryption key using the key wrapping key, decrypt existing data from the data lake using the encryption key, encrypt new data written by the service using the encryption key, and store the new data in the data lake.

Example 21 includes the subject matter of any one or more of Examples 15-20 and optionally the instructions, when executed, cause the processor to determine whether the data lake has expired based on a duration of time and, in response to determining that the data lake has expired, direct the edge device to delete the encryption key and data from the data lake.

Example 22 includes an apparatus to manage a data lake. The example apparatus includes means for selecting location to select an edge device to store the data lake, means for generating keys to, in response to an indication that a service is authorized to access the data lake, generate an encryption key corresponding to the data lake and generate a key wrapping key corresponding to the edge device, and means for distributing keys to wrap the encryption key using the key wrapping key and distribute the encryption key and the key wrapping key to the edge device, the encryption key to enable the service on the edge device to access the data lake.

Example 23 includes the apparatus of Example 22, where the edge device is a first edge device, the data lake including a first data lake region and a second data lake region, the first data lake region stored on the first edge device, and the second data lake region stored on at least one of the first edge device or a second edge device.

Example 24 includes the subject matter of any one or more of Examples 22 and/or 23 and optionally includes means for controlling a data lake table to generate a data lake table, where an entry of the data lake table includes at least one of a data lake ID corresponding to the data lake, a service ID corresponding to the service, the encryption key, an edge device identifier corresponding to the edge device, and an address range of the data lake in the edge device.

Example 25 includes the subject matter of any one or more of Examples 22-24 and optionally includes means for authorizing a service to determine whether the service is authorized to access the data lake, the data lake table controlling means to update the entry of the data lake table based on a result of the determination.

Example 26 includes the subject matter of any one or more of Examples 22-25 and optionally the encryption key is a first encryption key, and where the service authorizing means is to determine that the service is no longer authorized to access the data lake, the key generating means is to generate a second encryption key different from the first encryption key, the key distributing means is to distribute the second encryption key to the edge device, direct the edge device to decrypt data from the data lake using the first encryption key, and direct the edge device to re-encrypt the data using the second encryption key, and the data lake table controlling means is to remove the first encryption key and the service identifier from the entry of the data lake table and add the second encryption key to the entry of the data lake table.

Example 27 includes the subject matter of any one or more of Examples 22-26 and optionally the edge device is to unwrap the encryption key using the key wrapping key, decrypt existing data from the data lake using the encryption key, encrypt new data written by the service using the encryption key, and store the new data in the data lake.

Example 28 includes the subject matter of any one or more of Examples 22-27 and optionally includes means for controlling timing to determine whether the data lake has expired based on a duration of time and, in response to determining that the data lake has expired, direct the edge device to delete the encryption key and data from the data lake.

Example 29 is an edge computing gateway, comprising processing circuitry to perform any of Examples 8-14.

Example 30 is a base station, comprising a network interface card and processing circuitry to perform any of Examples 8-14.

Example 31 is a computer-readable medium comprising instructions to perform any of Examples 8-14.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus to manage a data lake, the apparatus comprising:
a location selector to select an edge device to store the data lake;
a key generator to, in response to an indication that a service is authorized to access the data lake:
generate an encryption key corresponding to the data lake; and
generate a key wrapping key corresponding to the edge device; and
a key distributor to:
wrap the encryption key using the key wrapping key; and
distribute the encryption key and the key wrapping key to the edge device, the encryption key to enable the service on the edge device to access the data lake.

2. The apparatus of claim 1, wherein the edge device is a first edge device, the data lake including a first data lake region and a second data lake region, the first data lake region stored on the first edge device, and the second data lake region stored on at least one of the first edge device or a second edge device.

3. The apparatus of claim 1, further including a data lake table controller to generate a data lake table, wherein an entry of the data lake table includes at least one of a data lake ID corresponding to the data lake, a service ID corresponding to the service, the encryption key, an edge device identifier corresponding to the edge device, and an address range of the data lake in the edge device.

4. The apparatus of claim 3, further including a service authorizer to determine whether the service is authorized to access the data lake, the data lake table controller to update the entry of the data lake table based on a result of the determination.

5. The apparatus of claim 4, wherein the encryption key is a first encryption key, and wherein:
the service authorizer is to determine that the service is no longer authorized to access the data lake;
the key generator is to generate a second encryption key different from the first encryption key;
the key distributor is to:
distribute the second encryption key to the edge device; direct the edge device to decrypt data from the data lake using the first encryption key; and
direct the edge device to re-encrypt the data using the second encryption key; and
the data lake table controller is to:
remove the first encryption key and the service identifier from the entry of the data lake table; and
add the second encryption key to the entry of the data lake table.

6. The apparatus of claim 1, wherein the edge device is to:
unwrap the encryption key using the key wrapping key;
decrypt existing data from the data lake using the encryption key;
encrypt new data written by the service using the encryption key; and
store the new data in the data lake.

7. The apparatus of claim 1, further including a timing controller to: determine whether the data lake has expired based on a duration of time; and
in response to determining that the data lake has expired, direct the edge device to delete the encryption key and data from the data lake.

8. A method to manage a data lake, the method comprising:
selecting an edge device to store the data lake;
in response to an indication that a service is authorized to access the data lake:
generating an encryption key corresponding to the data lake; and
generating a key wrapping key corresponding to the edge device;
wrapping the encryption key using the key wrapping key; and
distributing the encryption key and the key wrapping key to the edge device, the encryption key to enable the service on the edge device to access the data lake.

9. The method of claim 8, wherein the edge device is a first edge device, the data lake including a first data lake region and a second data lake region, the first data lake region stored on the first edge device, and the second data lake region stored on at least one of the first edge device or a second edge device.

10-12. (canceled)

13. The method of claim 8, further including:
unwrapping the encryption key using the key wrapping key;
decrypting existing data from the data lake using the encryption key;
encrypting new data written by the service using the encryption key; and
storing the new data in the data lake.

14. The method of claim 8, further including:
determining whether the data lake has expired based on a duration of time; and
in response to determining that the data lake has expired, directing the edge device to delete the encryption key and data from the data lake.

15. A non-transitory computer readable storage medium comprising instructions that, when executed, cause a processor to at least:
select an edge device to store a data lake;
in response to an indication that a service is authorized to access the data lake:
generate an encryption key corresponding to the data lake; and
generate a key wrapping key corresponding to the edge device;
wrap the encryption key using the key wrapping key; and
distribute the encryption key and the key wrapping key to the edge device, the encryption key to enable the service on the edge device to access the data lake.

16. The non-transitory computer readable storage medium of claim 15, wherein the edge device is a first edge device, the data lake including a first data lake region and a second data lake region, the first data lake region stored on the first edge device, and the second data lake region stored on at least one of the first edge device or a second edge device.

17. The non-transitory computer readable storage medium of claim 15, wherein the instructions, when executed, cause the processor to generate a data lake table, wherein an entry of the data lake table includes at least one of a data lake ID corresponding to the data lake, a service ID corresponding to the service, the encryption key, an edge device identifier corresponding to the edge device, and an address range of the data lake in the edge device.

18. The non-transitory computer readable storage medium of claim 17, wherein the instructions, when executed, cause the processor to determine whether the service is authorized to access the data lake, and update the entry of the data lake table based on a result of the determination.

19. The non-transitory computer readable storage medium of claim 18, wherein the encryption key is a first encryption key, and wherein the instructions, when executed, cause the processor to:
determine that the service is no longer authorized to access the data lake;
generate a second encryption key different from the first encryption key;
distribute the second encryption key to the edge device;
direct the edge device to decrypt data from the data lake using the first encryption key;
direct the edge device to re-encrypt the data using the second encryption key;
remove the first encryption key and the service identifier from the entry of the data lake table; and
add the second encryption key to the entry of the data lake table.

20. The non-transitory computer readable storage medium of claim 15, wherein the instructions, when executed, cause the processor to:
unwrap the encryption key using the key wrapping key;
decrypt existing data from the data lake using the encryption key;
encrypt new data written by the service using the encryption key; and
store the new data in the data lake.

21. The non-transitory computer readable storage medium of claim 15, wherein the instructions, when executed, cause the processor to:
determine whether the data lake has expired based on a duration of time; and
in response to determining that the data lake has expired, direct the edge device to delete the encryption key and data from the data lake.

22. An apparatus to manage a data lake, the apparatus comprising:
means for selecting location to select an edge device to store the data lake;
means for generating keys to, in response to an indication that a service is authorized to access the data lake:
generate an encryption key corresponding to the data lake; and
generate a key wrapping key corresponding to the edge device; and
means for distributing keys to:
wrap the encryption key using the key wrapping key; and
distribute the encryption key and the key wrapping key to the edge device, the encryption key to enable the service on the edge device to access the data lake.

23. The apparatus of claim 22, wherein the edge device is a first edge device, the data lake including a first data lake region and a second data lake region, the first data lake region stored on the first edge device, and the second data lake region stored on at least one of the first edge device or a second edge device.

24. The apparatus of claim 22, further including means for controlling a data lake table to generate a data lake table, wherein an entry of the data lake table includes at least one of a data lake ID corresponding to the data lake, a service ID corresponding to the service, the encryption key, an edge device identifier corresponding to the edge device, and an address range of the data lake in the edge device.

25. The apparatus of claim 24, further including means for authorizing a service to determine whether the service is authorized to access the data lake, the data lake table controlling means to update the entry of the data lake table based on a result of the determination.

26. The apparatus of claim 25, wherein the encryption key is a first encryption key, and wherein:
the service authorizing means is to determine that the service is no longer authorized to access the data lake;
the key generating means is to generate a second encryption key different from the first encryption key;
the key distributing means is to:
distribute the second encryption key to the edge device;
direct the edge device to decrypt data from the data lake using the first encryption key; and
direct the edge device to re-encrypt the data using the second encryption key; and
the data lake table controlling means is to:
remove the first encryption key and the service identifier from the entry of the data lake table; and
add the second encryption key to the entry of the data lake table.

27. The apparatus of claim 22, wherein the edge device is to:
unwrap the encryption key using the key wrapping key;
decrypt existing data from the data lake using the encryption key;
encrypt new data written by the service using the encryption key; and
store the new data in the data lake.

28. The apparatus of claim 22, further including means for controlling timing to:
determine whether the data lake has expired based on a duration of time; and
in response to determining that the data lake has expired, direct the edge device to delete the encryption key and data from the data lake.
